(19) United States
(12) Patent Application Publication
(10) Pub. No.: US 2014/0104383 A1
(43) Pub. Date: Apr. 17, 2014

(54) IMAGE PROCESSING DEVICE AND METHOD

(71) Applicants: Takahashi Yoshitomo, Kanagawa (JP); Shinobu Hattori, Tokyo (JP)

(72) Inventors: Takahashi Yoshitomo, Kanagawa (JP); Shinobu Hattori, Tokyo (JP)

(73) Assignee: Sony Corporation, Tokyo (JP)

(21) Appl. No.: 14/125,451

(22) PCT Filed: Jun. 14, 2012
(86) PCT No.: PCT/JP2012/065236

§ 371 Date: Dec. 11, 2013

(30) Foreign Application Priority Data
Jun. 22, 2011 (JP) 2011-138028

(51) Int. Cl. H04N 13/00; H04N 19/51; H04N 19/597

(52) U.S. Cl. CPC H04N 13/0048; H04N 19/00769; H04N 19/00684; H04N 19/00696
USPC 348/43

(57) ABSTRACT

The present technique relates to an image processing device and method that can increase encoding efficiency in multi-view encoding. A predicted vector generation unit generates a predicted vector by using a motion disparity vector of a peripheral region located in the vicinity of the current region. When a predicted vector of a disparity vector is to be determined, but it is not possible to refer to any of the peripheral regions at this point, the predicted vector generation unit sets the minimum disparity value or the maximum disparity value supplied from a disparity detection unit as the predicted vector. The present disclosure can be applied to image processing devices, for example.

### TECHNICAL FIELD

The present disclosure relates to image processing devices and methods, and more particularly, to an image processing device and method that can increase encoding efficiency in multi-view encoding.

### BACKGROUND ART

In recent years, apparatuses that compress images by implementing an encoding method for compressing image information through orthogonal transforms such as discrete cosine transforms and motion compensation by using redundancy inherent to image information, have been spreading so as to handle image information as digital information and achieve high-efficiency information transmission and accumulation in doing do. This encoding method may be MPEG (Moving Picture Experts Group), for example.

Particularly, MPEG2 (ISO/IEC 13818-2) is defined as a general-purpose image encoding standard, and is applicable to interlaced images and non-interlaced images, and to standard-resolution images and high-definition images. MPEG2 is currently used in a wide range of applications for professionals and general consumers, for example. By using the MPEG2 compression method, a bit rate of 4 to 8 Mbps is assigned to a standard-resolution interlaced image having 720×480 pixels, for example. Also, by using the MPEG2 compression method, a bit rate of 18 to 22 Mbps is assigned to a high-resolution interlaced image having 1920×1088 pixels, for example. In this manner, a high compression rate and excellent image quality can be realized.

MPEG2 is designed mainly for high-quality image encoding suited for broadcasting, but is not compatible with lower bit rates than MPEG1 or encoding methods involving higher compression rates. As mobile terminals are becoming popular, the demand for such encoding methods is expected to increase in the future, and to meet the demand, the MPEG4 encoding method was standardized. As for an image encoding method, the ISO/IEC 14496-2 standard was approved as an international standard in December 1998.

On the standardization schedule, the standard was approved as an international standard under the name of H.264 and MPEG-4 Part 10 (Advanced Video Coding, hereinafter referred to as H.264/AVC) in March 2003.

As an extension of H.264/AVC, FRExt (Fidelity Range Extension) was standardized in February 2005. FRExt includes coding tools for business use, such as RGB, 4:2:2, and 4:4:4, and the 8×8 DCT and quantization matrix specified in MPEG-2. As a result, an encoding method for enabling excellent presentation of movies containing film noise was realized by using H.264/AVC, and the encoding method is now used in a wide range of applications such as Blu-ray Disc (a trade name).

However, there is an increasing demand for encoding at a higher compression rate so as to compress images having a resolution of about 4000×2000 pixels, which is four times higher than the high-definition image resolution, or distribute high-definition images in today's circumstances where transmission capacities are limited as in the Internet. Therefore, studies on improvement in encoding efficiency are still continued by VCEG (Video Coding Expert Group) under ITU-T.

At present, to achieve higher encoding efficiency than that of H.264/AVC, an encoding method called HEVC (High Efficiency Video Coding) is being developed as a standard by JCTVC (Joint Collaboration Team-Video Coding), which is a joint standards organization of ITU-T and ISO/IEC. As for HEVC, Non-Patent Document 1 has been issued as a draft.

In the draft for HEVC, a process to generate a predicted vector is described. A predicted vector is predicted from the motion vector of a peripheral block located in the vicinity of the current block, and 0 is used as the predicted vector when it is not possible to refer to those reference blocks.

### CITATION LIST

### Non-Patent Document

Non-Patent Document 1: Thomas Wiegand, Woo-jin Han, Benjamin Bross, Jens-Rainer Ohm, and Gary J. Sullivian, “WD3: Working Draft 3 of High-Efficiency Video Coding”, JCTVc-E603, March 2011

### SUMMARY OF THE INVENTION

### Problems to be Solved by the Invention

In the draft for HEVC, there is no description of a disparity vector. In a case where the same method as above is used for disparity vectors, however, efficiency is not high. Specifically, in a case where it is not possible to refer to peripheral blocks and 0 is used as the predicted vector, the disparity vector is transmitted as it is to the decoding side. Therefore, encoding efficiency might become lower.

The present disclosure is made in view of those circumstances, and is to increase encoding efficiency in multi-view encoding.

### Solutions to Problems

An image processing device of one aspect of the present disclosure includes: a decoding unit that generates an image by decoding a bit stream; a predicted vector determination unit that determines a predicted vector to be the upper limit value or the lower limit value of a range of inter-image disparity between the image obtained from the bit stream and a view image having different disparity from the image at the same time, when a disparity vector of a region to be decoded in the image generated by the decoding unit is to be predicted and it is not possible to refer to any of peripheral regions located in the vicinity of the region; and a predicted image generation unit that generates a predicted image of the image generated by the decoding unit, using the predicted vector determined by the predicted vector determination unit.

The upper limit value or the lower limit value of the range of the inter-image disparity is the maximum value or the minimum value of the inter-image disparity.

The decoding may receive a flag indicating which of the upper limit value and the lower limit value of the range of the inter-image disparity is to be used as the predicted vector, and the predicted vector determination unit may determine the predicted vector to be the value indicated by the flag received by the decoding.

The predicted vector generation unit may determine the predicted vector to be one of the upper limit value, the lower limit value, and the mean value of the range of the inter-image disparity.

The predicted vector generation unit may determine the predicted vector to be one of the upper limit value and the lower limit value of the range of inter-image disparity and a predetermined value within the range of the inter-image disparity.

The predicted vector generation unit may determine the predicted vector to be the value obtained by performing scaling on the upper limit value or the lower limit value of the range of inter-image disparity, when the image indicated by the reference image index of the image differs from the view image.

An image processing method of the one aspect of the present disclosure includes: generating an image by decoding a bit stream; determining a predicted vector to be the upper limit value or the lower limit value of a range of inter-image disparity between the image obtained from the bit stream and a view image having different disparity from the image at the same time, when a disparity vector of a region to be decoded in the generated image is to be predicted and it is not possible to refer to any of peripheral regions located in the vicinity of the region; and generating a predicted image of the generated image, using the determined predicted vector, an image processing device generating the image, determining the predicted vector, and generating the predicted image.

An image processing device of another aspect of the present disclosure includes: a predicted vector determination unit that determines a predicted vector to be the upper limit value or the lower limit value of a range of inter-image disparity between an image and a view image having different disparity from the image at the same time, when a disparity vector of a region to be encoded in the image is to be predicted and it is not possible to refer to any of peripheral regions located in the vicinity of the region; and an encoding unit that encodes a difference between the disparity vector of the region and the predicted vector determined by the predicted vector determination unit.

The upper limit value or the lower limit value of the range of the inter-image disparity is the maximum value or the minimum value of the inter-image disparity.

The image processing device may further include a transmission unit that transmits a flag indicating which of the upper limit value and the lower limit value of the range of the inter-image disparity has been determined as the predicted vector by the predicted vector determination unit, and an encoded stream generated by encoding the image.

The predicted vector generation unit may determine the predicted vector to be one of the upper limit value, the lower limit value, and the mean value of the range of the inter-image disparity.

The predicted vector generation unit may determine the predicted vector to be one of the upper limit value and the lower limit value of the range of inter-image disparity and a predetermined value within the range of the inter-image disparity.

The predicted vector generation unit may determine the predicted vector to be the value obtained by performing scaling on the upper limit value or the lower limit value of the range of inter-image disparity, when the image indicated by the reference image index of the image differs from the view image.

An image processing method of another aspect of the present disclosure includes: determining a predicted vector to be an upper limit value or a lower limit value of a range of inter-image disparity between an image and a view image having different disparity from the image at the same time, when a disparity vector of a region to be encoded in the image is to be predicted and it is not possible to refer to any of peripheral regions located in the vicinity of the region; and encoding a difference between the disparity vector of the region and the determined predicted vector, an image processing device determining the predicted vector and encoding the difference.

In the one aspect of the present disclosure, an image is generated by decoding a bit stream. In a case where a disparity vector of a region to be decoded in the generated image is to be predicted, and it is not possible to refer to any peripheral region located in the vicinity of the region, the predicted vector is determined to be the upper limit value or the lower limit value of the range of the inter-image disparity between the image obtained from the bit stream and a view image having different disparity from the image at the same time. A predicted image of the generated image is then generated by using the determined predicted vector.

In another aspect of the present disclosure, when a disparity vector of a region to be encoded in an image is to be predicted and it is not possible to refer to any peripheral region located in the vicinity of the region, a predicted vector is determined to be the upper limit value or the lower limit value of a range of inter-image disparity between the image and a view image having different disparity from the image at the same time. A difference between the disparity vector of the region and the determined predicted vector is then encoded.

Each of the above described image processing devices may be an independent device, or may be an internal block in an image encoding device or an image decoding device.

### Effects of the Invention

According to one aspect of the present disclosure, images can be decoded. Particularly, encoding efficiency can be increased.

According to another aspect of the present disclosure, images can be encoded. Particularly, encoding efficiency can be increased.

### BRIEF DESCRIPTION OF DRAWINGS

FIG. 1 is a diagram for explaining a depth image (a view image).

FIG. 2 is a block diagram showing a typical example structure of an image encoding device.

FIG. 3 is a diagram showing an example of a reference relationship among views in three viewpoint images.

FIG. 4 is a diagram for explaining an example of predicted vector generation.

FIG. 5 is a block diagram showing an example structure of the motion disparity prediction/compensation unit.

FIG. 6 is a table showing an example of syntax in a sequence parameter set.

FIG. 7 is a table showing an example of syntax in a slice header.

FIG. 8 is a flowchart for explaining an example flow in an encoding process.

FIG. 9 is a flowchart for explaining an example flow in an inter motion disparity prediction process.

FIG. 10 is a flowchart for explaining an example flow in a motion disparity vector prediction process.

FIG. 11 is a flowchart for explaining an example flow in a motion disparity vector prediction process in a merge mode.

FIG. 12 is a block diagram showing a typical example structure of an image decoding device.

FIG. 13 is a block diagram showing an example structure of the motion disparity prediction/compensation unit.

FIG. 14 is a flowchart for explaining an example flow in a decoding process.

FIG. 15 is a flowchart for explaining an example flow in an inter motion disparity prediction process.

FIG. 16 is a flowchart for explaining an example flow in a motion disparity vector prediction process.

FIG. 17 is a flowchart for explaining an example flow in a motion disparity vector prediction process in a merge mode.

FIG. 18 is a block diagram showing a typical example structure of a personal computer.

FIG. 19 is a block diagram schematically showing an example structure of a television apparatus.

FIG. 20 is a block diagram schematically showing an example structure of a portable telephone device.

FIG. 21 is a block diagram schematically showing an example structure of a recording/reproducing device.

FIG. 22 is a block diagram schematically showing an example structure of an imaging device.

### MODES FOR CARRYING OUT THE INVENTION

Modes for carrying out the present disclosure (hereinafter referred to as the embodiments) will be described below. Explanation will be made in the following order.

### 1. Description of a Depth Image in This Specification

### 2. First Embodiment (Image Encoding Device)

### 3. Second Embodiment (Image Decoding Device)

### 4. Third Embodiment (Personal Computer)

### 5. Fourth Embodiment (Television Receiver)

### 6. Fifth Embodiment (Portable Telephone Device)

### 7. Sixth Embodiment (Hard Disk Recorder)

### 8. Seventh Embodiment (Camera)

### 1. Description of a Depth Image in this Specification

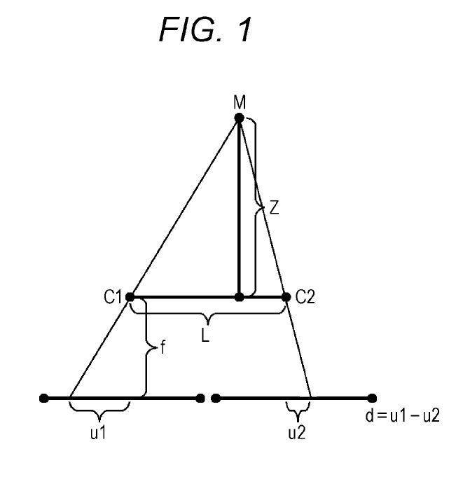

FIG. 1 is a diagram for explaining disparity and depth.

As shown in FIG. 1, in a case where a color image of an object M is to be imaged by a camera c1 positioned in a position C1 and a camera c2 positioned in a position C2, a depth Z that is the distance of the object M from the camera c1 (the camera c2) in the depth direction is defined by the following equation (1).

Z=(L/d)×f [Mathematical Formula 1]

Here, L represents the distance between the position C1 and the position C2 in the horizontal direction (hereinafter referred to as the inter-camera distance). Meanwhile, d represents the value obtained by subtracting the distance u2 between the position of the object M in the color image captured by the camera c2 and the center of the color image in the horizontal direction, from the distance u1 between the position of the object M in the color image captured by the camera c1 and the center of the color image in the horizontal direction. That is, d represents disparity. Further, f represents the focal length of the camera c1, and the camera c1 and the camera c2 have the same focal length in the equation (1).

As shown in the equation (1), the disparity d and the depth Z can be uniquely transformed. Accordingly, in this specification, an image indicating the disparity d of the two viewpoint color images captured by the camera c1 and the camera c2, and an image indicating the depth Z are collectively called depth images (view images).

A depth image (a view image) is an image representing the disparity d or the depth Z, and the pixel value of the depth image (the view image) is not the disparity d or the depth Z as it is, but may be a value obtained by normalizing the disparity d or a value obtained by normalizing the reciprocal 1/Z of the depth Z.

The value I obtained by normalizing the disparity d with eight bits (0 through 255) can be determined by the following equation (2). It should be noted that the number of normalization bits for the disparity d is not limited to eight, but may be some other number such as 10 or 12.

$$\begin{matrix}[ Mathematical Formula 2 ] & \\ I = \frac{255 \times ( d - {D}_{min} )}{{D}_{max} - {D}_{min}} & ( 2 )\end{matrix}$$

In the equation (2), Dₘₐₓ represents the maximum value of the disparity d, and Dₘᵢₙ represents the minimum value of the disparity d. The maximum value Dₘₐₓ and the minimum value Dₘᵢₙ may be set for each screen, or may be set for each set of more than one screen.

The value y obtained by normalizing the reciprocal 1/Z of the depth Z with eight bits (0 through 255) can also be determined by the following equation (3). It should be noted that the number of normalization bits for the reciprocal 1/Z of the depth Z is not limited to eight, but may be some other number such as 10 or 12.

$$\begin{matrix}[ Mathematical Formula 3 ] & \\ y = 255 \times \frac{\frac{1}{Z} - \frac{1}{{Z}_{far}}}{\frac{1}{{Z}_{near}} - \frac{1}{{Z}_{far}}} & ( 3 )\end{matrix}$$

In the equation (3), Z_{far} represents the maximum value of the depth Z, and Zₙₑₐᵣ represents the minimum value of the depth Z. The maximum value Z_{far} and the minimum value Zₙₑₐᵣ may be set for each screen, or may be set for each set of more than one screen.

As described above, in this specification, in view of that the disparity d and the depth Z can be uniquely transformed, an image having a pixel value that is a value I obtained by normalizing the disparity d, and an image having a pixel value that is a value y obtained by normalizing the reciprocal 1/Z of the depth Z are collectively referred to as depth images (view images). Here, the color format of depth images (view images) is YUV420 or YUV400, but may also be some other color format.

In a case where attention is paid to the information about the value I or the value y, instead of the pixel value of a depth image (a view image), the value I or the value y is set as depth information (disparity information/view information). Further, a depth map (a disparity map) is formed by mapping the value I or the value y.

### 2. First Embodiment

### [Example Structure of an Image Encoding Device]

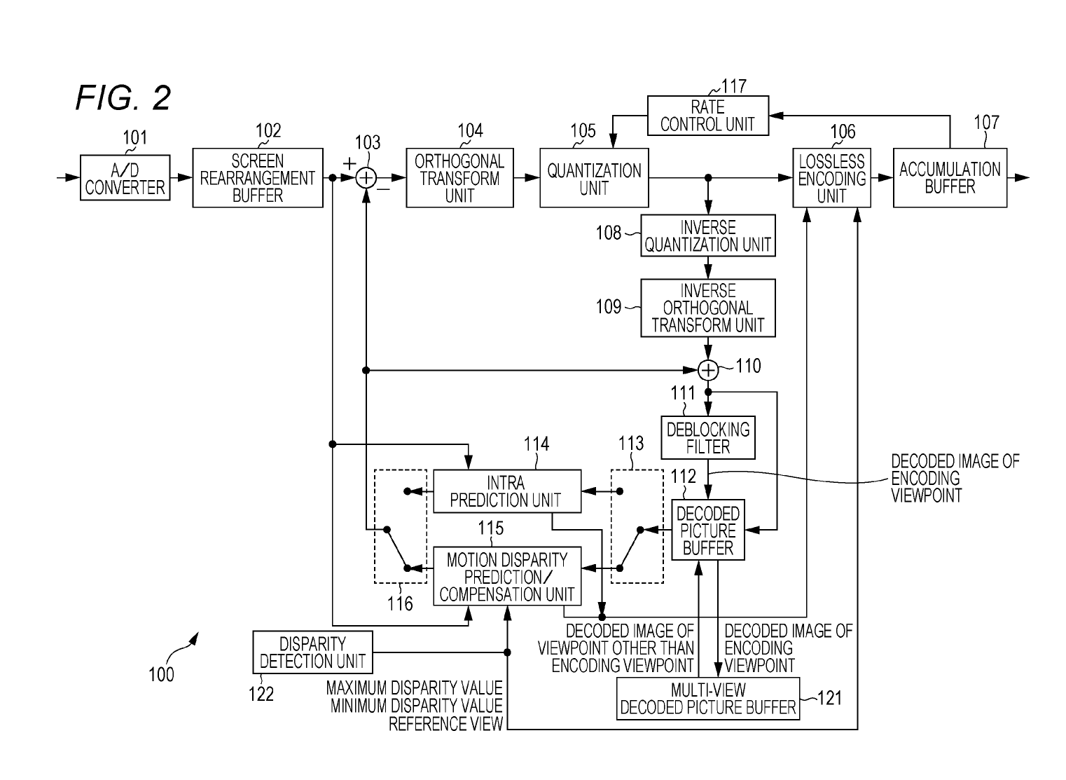

FIG. 2 shows the structure of an embodiment of an image encoding device as an image processing device to which the present disclosure is applied.

The image encoding device 100 shown in FIG. 2 encodes image data by using prediction processes. The encoding method used here may be H.264 and MPEG (Moving Picture Experts Group) 4 Part 10 (AVC (Advanced Video Coding)) (hereinafter referred to as H.264/AVC), or HEVC (High Efficiency Video Coding), for example.

In H.264/AVC, macroblocks or blocks are used as regions that serve as processing units. In HEVC, CUs (coding units), PUs (prediction units), TUs (transform units), or the like are used as regions that serve as processing units. That is, both a “block” and a “unit” means a “processing unit region”, and therefore, the term “processing unit region” or the term “current region”, which means either a block or a unit, will be used in the following description.

In the example shown in FIG. 2, the image encoding device 100 includes an A/D (Analog/Digital) converter 101, a screen rearrangement buffer 102, an arithmetic operation unit 103, an orthogonal transform unit 104, a quantization unit 105, a lossless encoding unit 106, an accumulation buffer 107, and an inverse quantization unit 108. The image encoding device 100 also includes an inverse orthogonal transform unit 109, an arithmetic operation unit 110, a deblocking filter 111, a decoded picture buffer 112, a selection unit 113, an intra prediction unit 114, a motion disparity prediction/compensation unit 115, a selection unit 116, and a rate control unit 117.

The image encoding device 100 further includes a multi-view decoded picture buffer 121 and a disparity detection unit 122.

The A/D converter 101 performs an A/D conversion on image data, outputs the image data to the screen rearrangement buffer 102, and stores the image data therein.

The screen rearrangement buffer 102 rearranges the image frames stored in displaying order in accordance with a GOP (Group of Pictures) structure, so that the frames are arranged in encoding order. The screen rearrangement buffer 102 supplies the image having the rearranged frame order to the arithmetic operation unit 103. The screen rearrangement buffer 102 also supplies the image having the rearranged frame order to the intra prediction unit 114 and the motion disparity prediction/compensation unit 115.

The arithmetic operation unit 103 subtracts a predicted image supplied from the intra prediction unit 114 or the motion disparity prediction/compensation unit 115 via the selection unit 116, from the image read from the screen rearrangement buffer 102, and outputs the difference information to the orthogonal transform unit 104.

When intra encoding is to be performed on an image, for example, the arithmetic operation unit 103 subtracts a predicted image supplied from the intra prediction unit 114, from the image read from the screen rearrangement buffer 102. When inter encoding is to be performed on an image, for example, the arithmetic operation unit 103 subtracts a predicted image supplied from the motion disparity prediction/compensation unit 115, from the image read from the screen rearrangement buffer 102.

The orthogonal transform unit 104 performs an orthogonal transforms, such as a discrete cosine transform or a Karhunen-Loeve transform, on the difference information supplied from the arithmetic operation unit 103, and supplies the transform coefficient to the quantization unit 105.

The quantization unit 105 quantizes the transform coefficient output from the orthogonal transform unit 104. The quantization unit 105 supplies the quantized transform coefficient to the lossless encoding unit 106.

The lossless encoding unit 106 performs lossless encoding, such as variable-length encoding or arithmetic encoding, on the quantized transform coefficient.

The lossless encoding unit 106 obtains information indicating an intra prediction mode and the like from the intra prediction unit 114, and obtains information indicating an inter prediction mode, motion disparity vector information, and the like from the motion disparity prediction/compensation unit 115.

The lossless encoding unit 106 not only encodes the quantized transform coefficient, but also incorporates (multiplexes) information such as the intra prediction mode information, the inter prediction mode information, and the motion disparity vector information, into the header information of encoded data. The lossless encoding unit 106 also incorporates a maximum disparity value and a minimum disparity value supplied from the disparity detection unit 122, and reference view information on which the maximum disparity value and the minimum disparity value are based, into the header information of the encoded data. The lossless encoding unit 106 supplies the encoded data obtained by the encoding to the accumulation buffer 107, and accumulates the encoded data therein.

For example, in the lossless encoding unit 106, a lossless encoding process such as variable-length encoding or arithmetic encoding is performed. The variable-length encoding may be CAVLC (Context-Adaptive Variable Length Coding), for example. The arithmetic encoding may be CABAC (Context-Adaptive Binary Arithmetic Coding) or the like.

The accumulation buffer 107 temporarily stores the encoded data supplied from the lossless encoding unit 106, and outputs the encoded data as an encoded image to a recording device or a transmission path (not shown) in a later stage at a predetermined time, for example.

The transform coefficient quantized by the quantization unit 105 is also supplied to the inverse quantization unit 108. The inverse quantization unit 108 inversely quantizes the quantized transform coefficient by a method corresponding to the quantization performed by the quantization unit 105. The inverse quantization unit 108 supplies the obtained transform coefficient to the inverse orthogonal transform unit 109.

The inverse orthogonal transform unit 109 performs an inverse orthogonal transform on the supplied transform coefficient by a method corresponding to the orthogonal transform process performed by the orthogonal transform unit 104. The output subjected to the inverse orthogonal transform (the restored difference information) is supplied to the arithmetic operation unit 110.

The arithmetic operation unit 110 adds the predicted image supplied from the intra prediction unit 114 or the motion disparity prediction/compensation unit 115 via the selection unit 116 to the inverse orthogonal transform result supplied from the inverse orthogonal transform unit 109 or the restored difference information. As a result, a locally decoded image (a decoded image) is obtained.

For example, when the difference information corresponds to an image to be intra-encoded, the arithmetic operation unit 110 adds the predicted image supplied from the intra prediction unit 114 to the difference information. When the difference information corresponds to an image to be inter-encoded, the arithmetic operation unit 110 adds the predicted image supplied from the motion disparity prediction/compensation unit 115 to the difference information, for example.

The addition result is supplied to the deblocking filter 111 and the decoded picture buffer 112.

The deblocking filter 111 removes block distortions from the decoded image by performing a deblocking filtering process where necessary. The deblocking filter 111 supplies the filtering process result to the decoded picture buffer 112.

A decoded image of an encoding viewpoint from the deblocking filter 111 or a decoded image of a viewpoint other than the encoding viewpoint from the multi-view decoded picture buffer 121 is accumulated in the decoded picture buffer 112. The decoded picture buffer 112 outputs a stored reference image to the intra prediction unit 114 or the motion disparity prediction/compensation unit 115 via the selection unit 113 at a predetermined time.

When intra encoding is to be performed on an image, for example, the decoded picture buffer 112 supplies the reference image to the intra prediction unit 114 via the selection unit 113. When inter encoding is to be performed on an image, for example, the decoded picture buffer 112 supplies the reference image to the motion disparity prediction/compensation unit 115 via the selection unit 113.

When the reference image supplied from the decoded picture buffer 112 is an image to be subjected to intra encoding, the selection unit 113 supplies the reference image to the intra prediction unit 114. When the reference image supplied from the decoded picture buffer 112 is an image to be subjected to inter encoding, the selection unit 113 supplies the reference image to the motion disparity prediction/compensation unit 115.

The intra prediction unit 114 performs intra predictions (intra-screen predictions) to generate a predicted image by using the pixel value in the screen. The intra prediction unit 114 performs intra predictions in more than one mode (intra prediction modes).

The intra prediction unit 114 generates predicted images in all the intra prediction modes, evaluates the respective predicted images, and selects an optimum mode. After selecting an optimum intra prediction mode, the intra prediction unit 114 supplies the predicted image generated in the optimum intra prediction mode to the arithmetic operation unit 103 and the arithmetic operation unit 110 via the selection unit 116.

As described above, the intra prediction unit 114 also supplies information such as the intra prediction mode information indicating the adopted intra prediction mode to the lossless encoding unit 106 where appropriate.

The motion disparity prediction/compensation unit 115 performs a motion disparity prediction on the image to be inter-encoded, by using the input image supplied from the screen rearrangement buffer 102 and the reference image supplied from the decoded picture buffer 112 via the selection unit 113. The motion disparity prediction/compensation unit 115 performs a motion disparity compensation process in accordance with a detected motion disparity vector, to generate a predicted image (inter predicted image information). Those processes are carried out in all candidate inter prediction modes, and determines an optimum inter prediction mode among those candidates. The motion disparity prediction/compensation unit 115 supplies the generated predicted image to the arithmetic operation unit 103 and the arithmetic operation unit 110 via the selection unit 116.

The motion disparity prediction/compensation unit 115 generates a predicted vector by using the motion disparity vector of a peripheral region located in the vicinity of the current region. When a predicted vector of a disparity vector is to be determined, but it is not possible to refer to any of the peripheral regions, the motion disparity prediction/compensation unit 115 sets the minimum disparity value or the maximum disparity value supplied from the disparity detection unit 122 as the predicted vector.

The motion disparity prediction/compensation unit 115 also supplies information such as the inter prediction mode information indicating the adopted inter prediction mode, the motion disparity vector information, a reference image index, and a predicted vector index, to the lossless encoding unit 106. The motion disparity vector information is information indicating the difference between the motion disparity vector and the predicted vector.

When intra encoding is to be performed on an image, the selection unit 116 supplies the output of the intra prediction unit 114 to the arithmetic operation unit 103 and the arithmetic operation unit 110. When inter encoding is to be performed on an image, the selection unit 116 supplies the output of the motion disparity prediction/compensation unit 115 to the arithmetic operation unit 103 and the arithmetic operation unit 110.

Based on the compressed images accumulated in the accumulation buffer 107, the rate control unit 117 controls the quantization operation rate of the quantization unit 105 so as not to cause an overflow or underflow.

The multi-view decoded picture buffer 121 replaces the decoded image of an encoding viewpoint accumulated in the decoded picture buffer 112 with a decoded image of a viewpoint other than the encoding viewpoint, in accordance with the current view (viewpoint).

The disparity detection unit 122 supplies the maximum disparity value and the minimum disparity value between the current image and the reference view image having different disparity from the current image at the same time, to the motion disparity prediction/compensation unit 115 and the lossless encoding unit 106. The disparity detection unit 122 further supplies the reference view information that is the information about the image to be referred to at the time of reference calculation, to the motion disparity prediction/compensation unit 115 and the lossless encoding unit 106. Here, the image to be referred to at the time of disparity calculation is called the reference view image. The maximum disparity value and the minimum disparity value, and the reference view information are input to the disparity detection unit 122 via an operation unit (not shown) by a stream maker, for example.

The maximum disparity value and the minimum disparity value are inserted into a slice header by the lossless encoding unit 106. The reference view information is inserted into a sequence parameter set.

[Prediction Mode Selection]

To achieve a higher encoding efficiency, it is critical to select an appropriate prediction mode. For example, in H.264/AVC, a method implemented in a reference software of H.264/MPEG-4 AVC, called JM (Joint Model) (available at http://iphome.hhi.de/suchring/tml/index.htm), can be used as an example of such a selection method.

In JM, the two mode determination methods described below, High Complexity Mode and Low Complexity Mode, can be selected. By either of the methods, an encoding cost value as to each prediction mode is calculated, and the prediction mode that minimizes the cost value is selected as the optimum mode for the target block or macroblock.

A cost function in High Complexity Mode can be calculated according to the following expression (4).

Cost (ModeεΩ)=D+λ*R (4)

Here, Ω represents the universal set of candidate modes for encoding a target block or macroblock, and D represents the difference energy between a decoded image and an input image when encoded is performed in the current prediction mode. λ represents the Lagrange's undetermined multiplier provided as a quantization parameter function. R represents the total bit rate in a case where encoding is performed in the current mode, including the orthogonal transform coefficient.

That is, to perform encoding in High Complexity Mode, a provisional encoding process needs to be performed in all the candidate modes to calculate the above parameters D and R, and therefore, a larger amount of calculation is required.

A cost function in Low Complexity Mode is expressed by the following expression (5).

Cost (ModeεΩ)=D+QP2Quant(QP)*HeaderBit (5)

Here, D differs from that in High Complexity Mode, and represents the difference energy between a predicted image and an input image. QP2Quant(QP) represents a function of a quantization parameter QP, and HeaderBit represents the bit rate related to information that excludes the orthogonal transform coefficient and belongs to Header, such as motion vectors and the mode.

That is, in Low Complexity Mode, a prediction process needs to be performed for each of the candidate modes, but a decoded image is not required. Therefore, there is no need to perform an encoding process. Accordingly, the amount of calculation is smaller than that in High Complexity Mode.

[Reference Relationship Among Three Viewpoint Images]

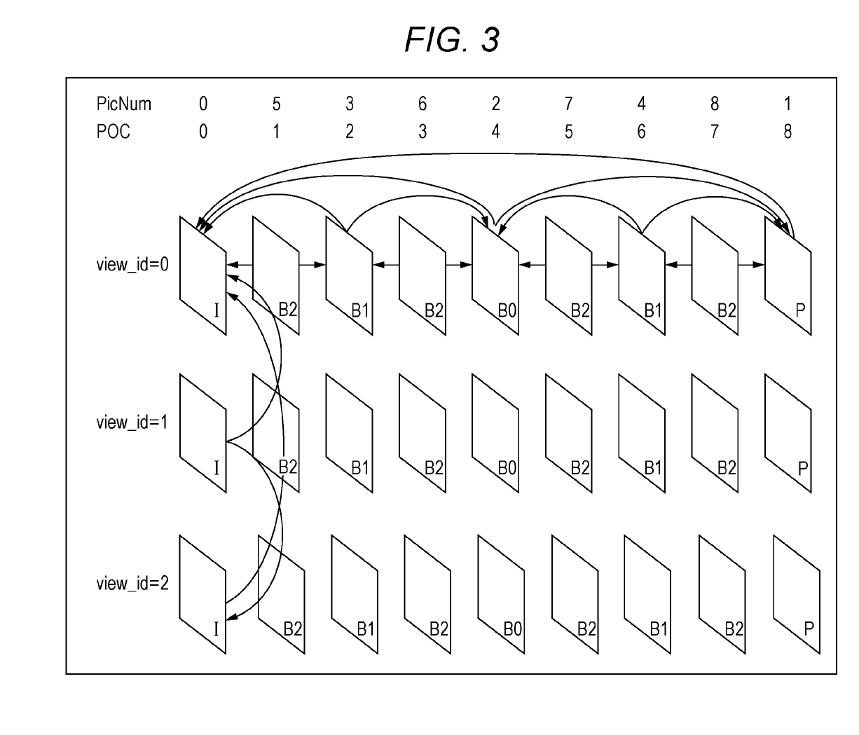

FIG. 3 is a diagram showing an example of a reference relationship among views in three viewpoint images. The example illustrated in FIG. 3 shows I-pictures, B2-pictures, B1-pictures, B2-pictures, B0-pictures, B2-pictures, B1-pictures, B2-pictures, and P-pictures in ascending order of POC (Picture Order Count: output order for pictures) from the left. Above the POC index, the PicNum (decoding order) index is also shown.

For example, a P-picture of PicNum=1 can refer to the corresponding decoded I-picture of PicNum=O. A B0-picture of PicNum=2 can refer to a decoded I-picture of PicNum=0 and a P-picture of PicNum=1. A B1-picture of PicNum=3 can refer to a decoded I-picture of PicNum=0 and a B0-picture of PicNum=2. A B1-picture of PicNum=4 can refer to a decoded B0-picture of PicNum=2 and a P-picture of PicNum=1.

Also, respective pictures of a view 0 (View_id_{—}0), a view 1 (View_id_{—}1), and a view 2 (View_id_{—}2) that have the same time information and different disparity information are sequentially shown from the top. The example illustrated in FIG. 3 shows a case where the view 0, the view 1, and the view 2 are decoded in this order.

The view 0 is called a base view, and an image thereof can be encoded by using a time prediction. The view 1 and the view 2 are called non-base views, and images thereof can be encoded by using a time prediction and a disparity prediction.

At the time of a disparity prediction, an image of the view 1 can refer to encoded images of the view 0 and the view 2, as indicated by arrows. Therefore, the P-picture of the view 1 at the eighth in POC is a P-picture in a time prediction, but is a B-picture in a disparity prediction.

At the time of a disparity prediction, an image of the view 2 can refer to an encoded image of the view 0, as indicated by an arrow.

In the three viewpoint images shown in FIG. 3, an image of the base view is first decoded, and images of the other views at the same time are decoded. After that, decoding of the image of the base view at the next time (PicNum) is started. In such order, decoding is performed.

[Generation of Predicted Vectors]

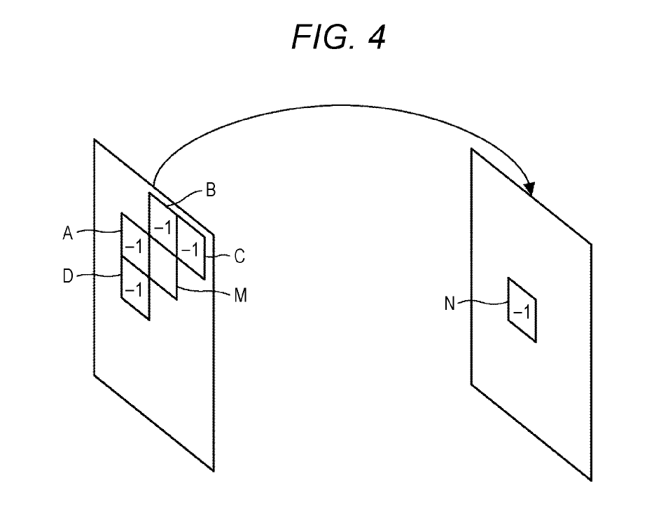

Referring now to FIG. 4, generation of predicted vectors in HEVC is described. The example illustrated in FIG. 4 shows a spatially-correlated region A to the left of a current region M, a spatially-correlated region B above the region M, a spatially-correlated region C to the upper right of the region M, and a spatially-correlated region D to the lower left of the region M in the same picture as the current region M. Also, a temporally-correlated region N in the same position as the region M is shown in a picture at a different time from the current region M, as indicated by the arrow. Those correlated regions are referred to as peripheral regions in this embodiment. That is, peripheral regions include spatially-peripheral regions and temporally-peripheral regions. It should be noted that “−1” in each region means that it is not possible to refer to the motion disparity vector of each region.

In HEVC, a predicted vector of the current region M is generated by using one of motion disparity vectors of the spatially-correlated regions A, B, C, and D spatially located in the vicinity, and the temporally-correlated region N temporally located in the vicinity.

However, when it is not possible to refer to any of the motion vectors of the spatially-correlated regions A, B, C, and D and the temporally-correlated region N since an intra prediction is performed or those regions are located outside the screen, the predicted vector of the current region M is set as a 0 vector.

In a case where the above described method is used for disparity vectors, the disparity vector detected in the current region is sent as it is to the decoding side, since the predicted vector is a 0 vector. As a result, there is a possibility that encoding efficiency becomes lower.

In view of this, the image encoding device 100 inserts the maximum disparity value and the minimum disparity value necessary for adjusting disparity and combining viewpoints on the display side into a slice header, and sends the slice header to the decoding side. If it is not possible to refer to any of the peripheral regions when a disparity vector is to be predicted, the image encoding device 100 uses one of the maximum disparity value and the minimum disparity value as a predicted vector.

There are cases where the view ID of the reference view image on which the minimum disparity value and the maximum disparity value are based differs from the view ID of the reference image for disparity vectors. In such cases, scaling in accordance with the distances of those views is performed on the minimum value or the maximum value, and the result is used as a predicted vector.

This will be described below in detail.

[Example Structure of the Motion Disparity Prediction/Compensation Unit]

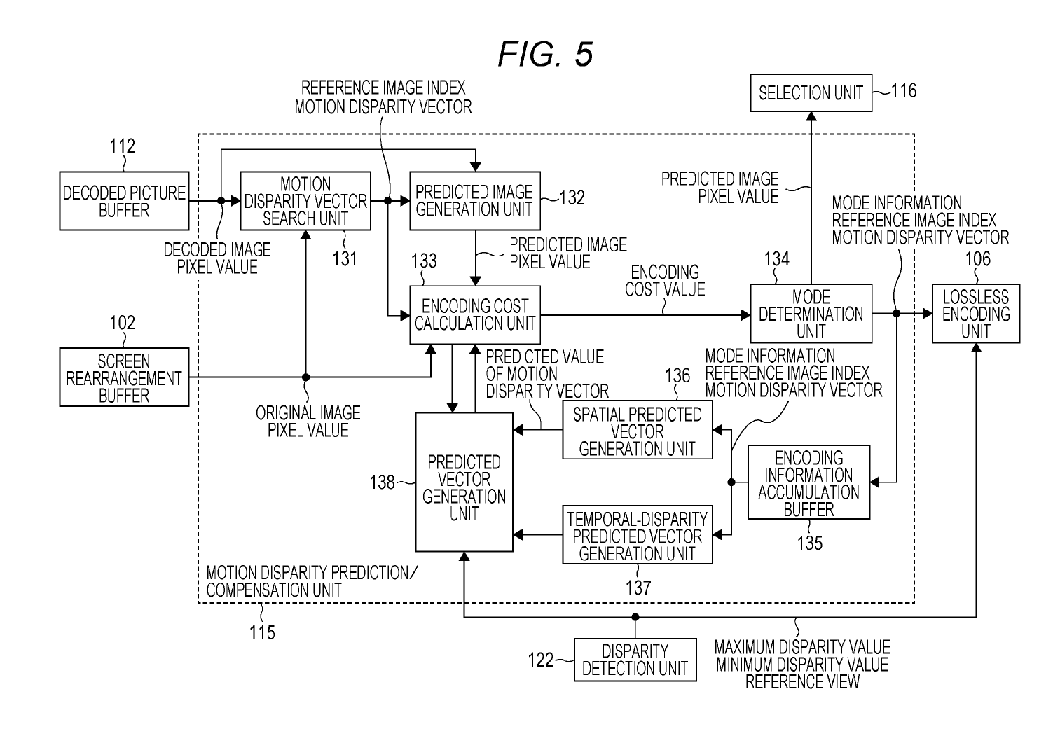

Next, the respective components of the image encoding device 100 are described. FIG. 5 is a block diagram showing an example structure of the motion disparity prediction/compensation unit 115. The example illustrated in FIG. 5 shows only the flow of principal information.

In the example illustrated in FIG. 5, the motion disparity prediction/compensation unit 115 is designed to include a motion disparity vector search unit 131, a predicted image generation unit 132, an encoding cost calculation unit 133, and a mode determination unit 134. The motion disparity prediction/compensation unit 115 is also designed to include an encoding information accumulation buffer 135, a spatial predicted vector generation unit 136, a temporal-disparity predicted vector generation unit 137, and a predicted vector generation unit 138.

A decoded image pixel value from the decoded picture buffer 112 is supplied to the motion disparity vector search unit 131 and the predicted image generation unit 132. An original image pixel value from the screen rearrangement buffer 102 is supplied to the motion disparity vector search unit 131 and the encoding cost calculation unit 133.

The motion disparity vector search unit 131 performs motion disparity predictions in all the candidate inter prediction modes by using the original image pixel value from the screen rearrangement buffer 102 and the decoded image pixel value from the decoded picture buffer 112, and searches for a motion disparity vector. The motion disparity vector search unit 131 supplies a detected motion disparity vector, the reference image index used as reference, and prediction mode information, to the predicted image generation unit 132 and the encoding cost calculation unit 133.

The predicted image generation unit 132 performs a motion disparity compensation process on the decoded image pixel value from the decoded picture buffer 112 by using the motion disparity vector from the motion disparity vector search unit 131, and generates a predicted image. The predicted image generation unit 132 supplies the generated predicted image pixel value to the encoding cost calculation unit 133.

The original image pixel value from the screen rearrangement buffer 102, the motion disparity vector from the motion disparity vector search unit 131, the reference image index, the prediction mode information, and the predicted image pixel value from the predicted image generation unit 132 are supplied to the encoding cost calculation unit 133. Further, the predicted value (or the predicted vector) of the motion disparity vector from the predicted vector generation unit 138 is supplied to the encoding cost calculation unit 133.

The encoding cost calculation unit 133 calculates encoding cost values by using the supplied information and the cost function of the above described expression (4) or (5). The encoding cost calculation unit 133 supplies the calculated encoding cost values to the mode determination unit 134. At this point, the encoding cost calculation unit 133 also supplies the information supplied from the respective components, to the mode determination unit 134.

The mode determination unit 134 compares the encoding cost values from the encoding cost calculation unit 133 with one another, to determine an optimum inter prediction mode. The mode determination unit 134 also determines, for each slice, whether the maximum disparity value or the minimum disparity value should be used as the predicted vector based on the encoding cost values. In a case where there is more than one candidate for the predicted vector, the mode determination unit 134 selects the optimum candidate as the predicted vector based on the encoding cost values.

The mode determination unit 134 supplies the pixel value of the predicted image in the determined optimum inter prediction mode to the selection unit 116. The mode determination unit 134 also supplies the mode information indicating the determined optimum inter prediction mode, the reference image index, the predicted vector index, motion disparity vector information indicating the difference between the motion disparity vector and the predicted vector, to the lossless encoding unit 106. At this point, a flag indicating which one of the maximum disparity value and the minimum disparity value is to be used and is to be inserted into the slice header is also supplied to the lossless encoding unit 106.

Further, the mode determination unit 134 supplies the mode information, the reference image index, and the motion disparity vector, as encoding information about the peripheral regions, to the encoding information accumulation buffer 135.

The encoding information accumulation buffer 135 accumulates the encoding information about the peripheral regions, which are the mode information, the reference image index, the motion disparity vector, and the like.

The spatial predicted vector generation unit 136 acquires information such as the mode information about the peripheral regions, the reference image index, and the motion disparity vector from the encoding information accumulation buffer 135 if necessary, and generates a predicted vector of a spatial correlation of the current region by using those pieces of information. The spatial predicted vector generation unit 136 supplies the generated predicted vector of the spatial correlation and the information about the peripheral region used in the generation to the predicted vector generation unit 138.

The temporal-disparity predicted vector generation unit 137 acquires information such as the mode information about the peripheral regions, the reference image index, and the motion disparity vector from the encoding information accumulation buffer 135 if necessary, and generates a predicted vector of a temporal-disparity correlation of the current region by using those pieces of information. The temporal-disparity predicted vector generation unit 137 supplies the generated predicted vector of the temporal-disparity correlation and the peripheral region information used in the generation, to the predicted vector generation unit 138.

The predicted vector generation unit 138 acquires the minimum disparity value and the maximum disparity value, and the reference view information, from the disparity detection unit 122. The predicted vector generation unit 138 acquires the generated predicted vectors and the peripheral region information from the spatial predicted vector generation unit 136 and the temporal-disparity predicted vector generation unit 137. The predicted vector generation unit 138 also acquires the information about the reference image index of the current region from the encoding cost calculation unit 133.

By referring to the acquired information, the predicted vector generation unit 138 supplies the predicted vector generated by the spatial predicted vector generation unit 136 or the temporal-disparity predicted vector generation unit 137, a 0 vector, or a predicted vector determined from the minimum disparity value and the maximum disparity value, to the encoding cost calculation unit 133.

In a case where a motion vector is to be predicted (or where the reference image indicated by the reference image index is an image at a different time), the predicted vector generation unit 138 sets the 0 vector as the predicted vector when it is not possible to refer to any of the peripheral regions.

In a case where a disparity vector is to be predicted (or where the reference image indicated by the reference image index is a view at a different time), the predicted vector generation unit 138 sets the minimum disparity value or the maximum disparity value as a candidate for the predicted vector, and supplies the candidate to the encoding cost calculation unit 133 when it is not possible to refer to any of the peripheral regions. If the view ID of the reference view image on which the minimum disparity value and the maximum disparity value are based differs from the view ID of the reference image index at this point, the predicted vector generation unit 138 supplies candidate predicted vectors obtained by performing scaling on the minimum disparity value and the maximum disparity value, to the encoding cost calculation unit 133.

[Example of Syntax in a Sequence Parameter Set]

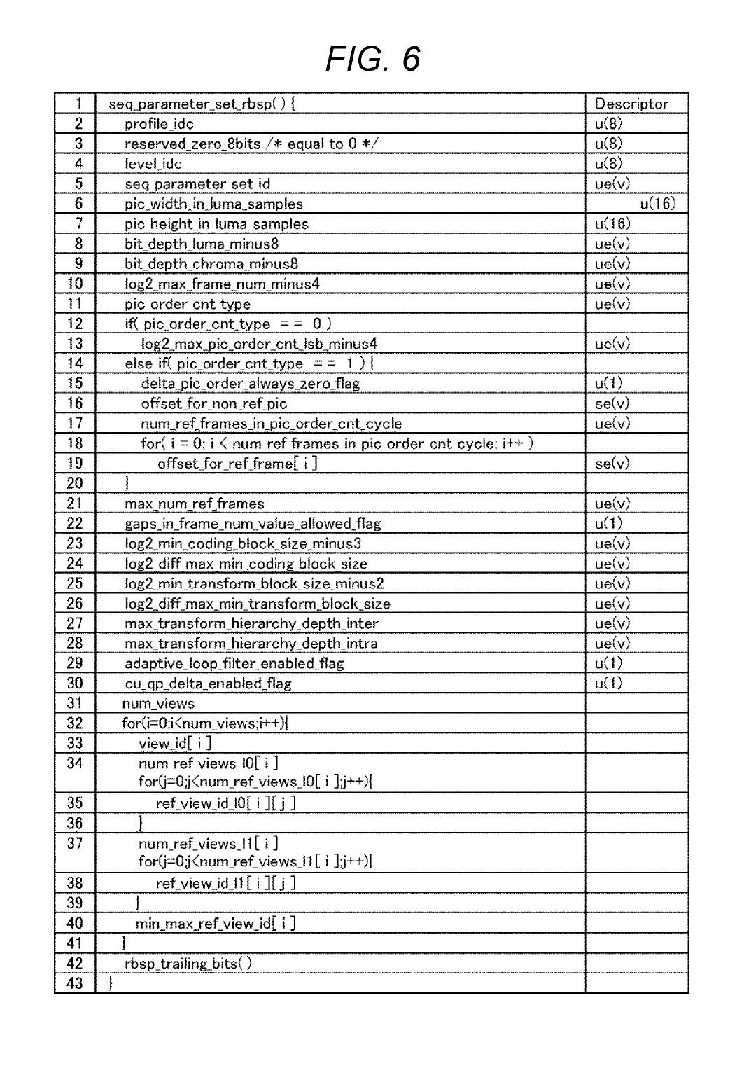

FIG. 6 is a table showing an example of syntax in a sequence parameter set. The number at the left end of each row is a row number provided for ease of explanation.

In the example shown in FIG. 6, max_num_ref_frames is set in the 21st row. This max_num_ref_frames indicates the largest value (number) of reference images in this stream.

View reference information is written in the 31st through 38th rows. For example, the view reference information is formed with the total number of views, a view_identifier, the number of disparity predictions in a list L0, the identifier of the reference view(s) in the list L0, the number of disparity predictions in a list L1, the identifier of the reference view(s) in the list L1, and the like.

Specifically, num_views is set in the 31st row. This num_views indicates the total number of views included in this stream.

In the 33rd row, view_id[i] is set. This view_id[i] is the identifier for distinguishing views from one another.

In the 34th row, num_ref_views_{—}10[i] is set. This num_ref_views_{—}10[i] indicates the number of disparity predictions in the list L0. In a case where “num_ref_views_{—}10[i]” shows 2, for example, it is possible to refer to only two views in the list L0.

In the 35th row, ref_view_id_{—}10[i][j] is set. This ref_view_id_{—}10[i][j] is the identifier of the view(s) to be used as reference in disparity predictions in the list L0. For example, in a case where “num_ref_views_{—}10[i]” shows 2 even though there are three views, “ref_view_id_{—}10[i][j]” is set for identifying the two views to be used as reference among the three views in the list L0.

In the 36th row, num_ref_views_{—}11[i] is set. This num_ref_views_{—}11[i] indicates the number of disparity predictions in the list L1. In a case where “num_ref_views_{—}11[i]” shows 2, for example, it is possible to refer to only two views in the list L1.

In the 37th row, ref_view_id_{—}11[i][j] is set. This ref_view_id_{—}11[i][j] is the identifier of the view(s) to be used as reference in disparity predictions in the list L1. For example, in a case where “num_ref_views_{—}11[i]” shows 2 even though there are three views, “ref_view_id_{—}11[i][j]” is set for identifying which two views are to be used as reference among the three views in the list L1.

In the 40th row, min_max_ref_view_id[i] is set. This min_max_ref_view_id[i] is the view ID of the reference view image (the reference view information) on which the minimum disparity value and the maximum disparity value are based.

If this view ID is the same as the view ID of the reference image index of the current region in a case where it is not possible to refer to any of the peripheral regions, the minimum disparity value or the maximum disparity value is not subjected to scaling but is set as the predicted vector. If this view ID differs from the view ID of the reference image index in a case where it is not possible to refer to any of the peripheral regions, the minimum disparity value or the maximum disparity value is subjected to scaling in accordance with the distance between those two views, and the result is set as the predicted vector.

[Example of Syntax in a Slice Header]

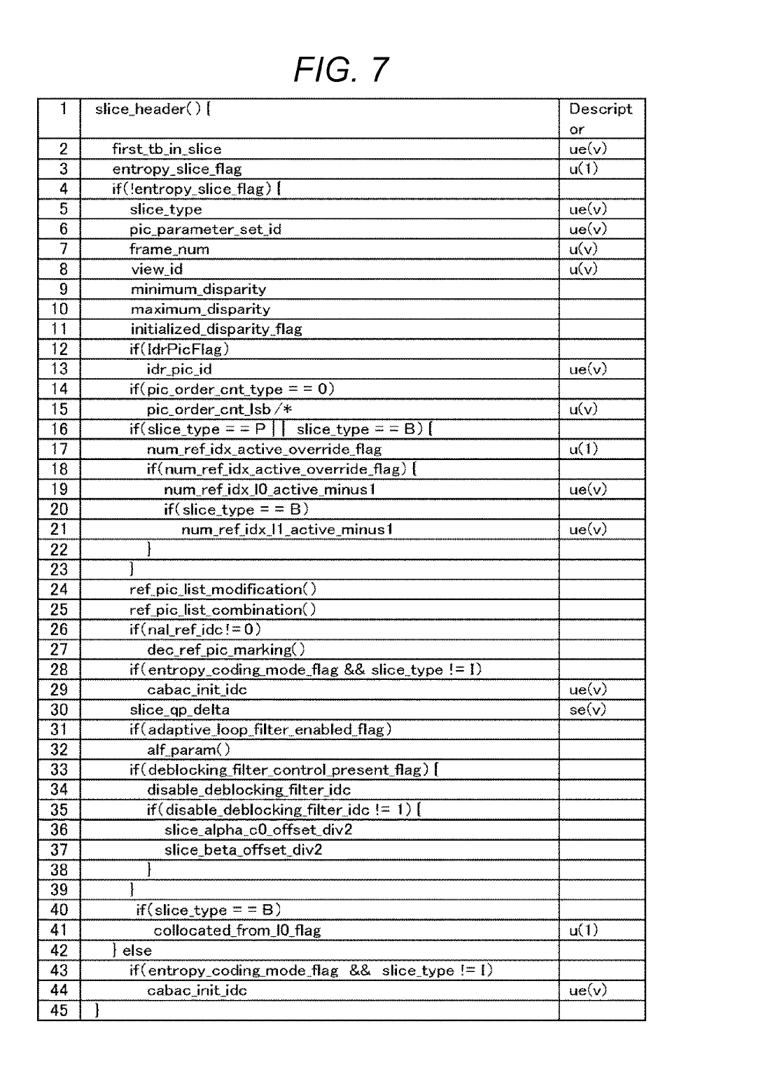

FIG. 7 is a table showing an example of syntax in a slice header. The number at the left end of each row is a row number provided for ease of explanation.

In the example shown in FIG. 7, slice_type is set in the fifth row. This slice_type indicates that this slice is an I-slice, a P-slice, or a B-slice.

In the eighth row, view_id is set. This view_id is the ID for identifying a view.

In the ninth row, minimum_disparity is set. This minimum_disparity indicates the minimum disparity value. In the 10th row, maximum_disparity is set. This maximum_disparity indicates the maximum disparity value.

In the 11th row, initialized_disparity_flag is set. This initialized_disparity_flag is the flag indicating which one of the minimum disparity value and the maximum disparity value is to be used as the value of a predicted vector.

That is, when initialized_disparity_flag=0, the minimum_disparity in the slice header is set as a predicted vector. When initialized_disparity_flag=1, the maximum_disparity in the slice header is set as a predicted vector.

In the 12th row, pic_order_cnt_lsb is set. This pic_order_cnt_lsb is time information (or POC: Picture Order Count).

By using the above syntax, a predicted vector is generated on the encoding side and the decoding side in the following manner. For example, A represents the viewpoint distance between a decoded picture and the reference image to be used as reference by a region to be decoded, B represents the viewpoint distance between the decoded picture and the reference view image, and pmv represents a predicted vector of the region to be decoded.

When A=B, a predicted vector is generated as shown in the following expressions (6).

initialized_disparity_flag=0→pmv=minimum_disparity

initialized_disparity_flag=1→pmv=maximum_disparity (6)

When A is not equal to B, a predicted vector is generated as shown in the following expressions (7).

initialized_disparity_flag=0→pmv=minimum_disparity*A/B

initialized_disparity_flag=1→pmv=maximum_disparity*A/B (7)

That is, a value subjected to scaling in accordance with the distance (A/B) between pictures is set as a predicted vector.

[Flow in an Encoding Process]

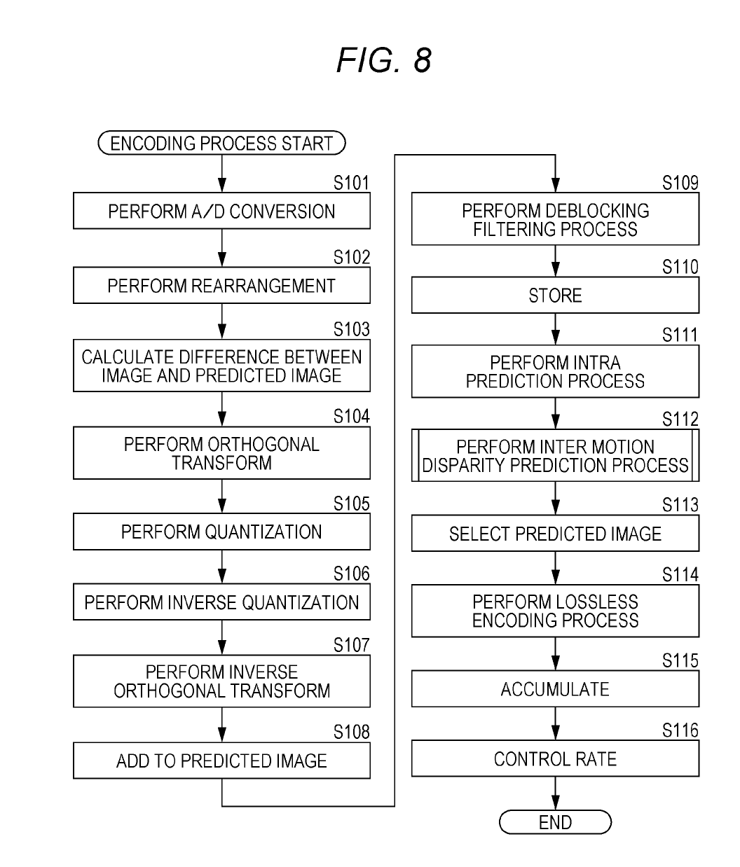

Next, the flow in each process to be performed by the above described image encoding device 100 is described. Referring first to the flowchart shown in FIG. 8, an example flow in an encoding process is described.

In step S101, the A/D converter 101 performs an A/D conversion on an input image. In step S102, the screen rearrangement buffer 102 stores the image subjected to the A/D conversion, and rearranges the respective pictures in encoding order, instead of displaying order.

In step S103, the arithmetic operation unit 103 calculates the difference between the image rearranged by the processing in step S102 and a predicted image. The predicted image is supplied to the arithmetic operation unit 103 via the selection unit 116 from the motion disparity prediction/compensation unit 115 when an inter prediction is to be performed, and from the intra prediction unit 114 when an intra prediction is to be performed.

The difference data is smaller in data amount than the original image data. Accordingly, the data amount can be made smaller than in a case where an image is directly encoded.

In step S104, the orthogonal transform unit 104 performs an orthogonal transform on the difference information generated by the processing in step S103. Specifically, an orthogonal transform such as a discrete cosine transform or a Karhunen-Loeve transform is performed, and a transform coefficient is output.

In step S105, the quantization unit 105 quantizes the orthogonal transform coefficient obtained by the processing in step S104.

The difference information quantized by the processing in step S105 is locally decoded in the following manner. In step S106, the inverse quantization unit 108 inversely quantizes the quantized orthogonal transform coefficient (also referred to as the quantized coefficient) generated by the processing in step S105, using properties corresponding to the properties of the quantization unit 105.

In step S107, the inverse orthogonal transform unit 109 performs an inverse orthogonal transform on the orthogonal transform coefficient obtained by the processing in step S106, using properties corresponding to the properties of the orthogonal transform unit 104.

In step S108, the arithmetic operation unit 110 adds the predicted image to the locally decoded difference information, and generates a locally decoded image (an image corresponding to the input to the arithmetic operation unit 103).

In step S109, the deblocking filter 111 performs a deblocking filtering process on the image generated by the processing in step S108. In this manner, block distortions (or distortions in processing unit regions) are removed.

In step S110, the decoded picture buffer 112 stores the image having block distortions removed by the processing in step S109. It should be noted that images that have not been subjected to filtering processes by the deblocking filter 111 are also supplied from the arithmetic operation unit 110 to the decoded picture buffer 112, and are stored therein.

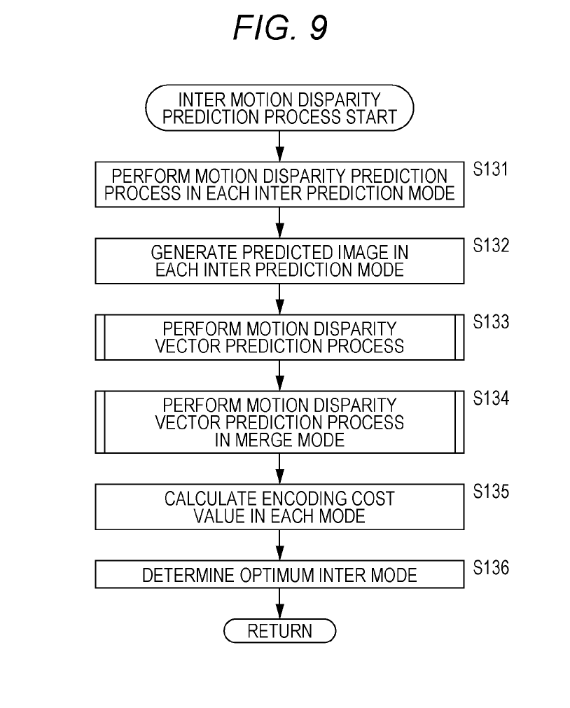

In step S111, the intra prediction unit 114 performs intra prediction processes in intra prediction modes. In step S112, the motion disparity prediction/compensation unit 115 performs an inter motion disparity prediction process to perform motion disparity predictions and motion disparity compensation in inter prediction modes. This inter motion disparity prediction process will be described later with reference to FIG. 9.

Through the processing in step S112, motion disparity is predicted in all the inter prediction modes, and predicted images are generated. A predicted vector is also generated for a motion disparity vector. When it is not possible to refer to any of the peripheral regions in a case where a predicted vector of a disparity vector is to be generated, the minimum disparity value or the maximum disparity value is set as a predicted vector. An encoding cost value is then calculated, an optimum inter prediction mode is determined, and the predicted image in the optimum inter prediction mode and the encoding cost value are output to the selection unit 116.

In step S113, the selection unit 116 determines an optimum prediction mode based on the respective encoding cost values that are output from the intra prediction unit 114 and the motion disparity prediction/compensation unit 115. Specifically, the selection unit 116 selects the predicted image generated by the intra prediction unit 114 or the predicted image generated by the motion disparity prediction/compensation unit 115.

The selection information indicating which predicted image has been selected is supplied to the intra prediction unit 114 or the motion disparity prediction/compensation unit 115, whichever has generated the selected predicted image. When the predicted image generated in the optimum intra prediction mode is selected, the intra prediction unit 114 supplies the information indicating the optimum intra prediction mode (or intra prediction mode information) to the lossless encoding unit 106.

When the predicted image generated in the optimum inter prediction mode is selected, the motion disparity prediction/compensation unit 115 outputs the information indicating the optimum inter prediction mode, as well as information corresponding to the optimum inter prediction mode, if necessary, to the lossless encoding unit 106. The information corresponding to the optimum inter prediction mode includes motion disparity vector information, a predicted vector index, an initialized_disparity flag, a reference image index, and the like.

In step S114, the lossless encoding unit 106 encodes the transform coefficient quantized by the processing in step S105. That is, lossless encoding such as variable-length encoding or arithmetic encoding is performed on the difference image (a second-order difference image in the case of an inter prediction).

The lossless encoding unit 106 also encodes the information about the prediction mode of the predicted image selected by the processing in step S113, and adds the encoded information to the encoded data obtained by encoding the difference image. Specifically, the lossless encoding unit 106 also encodes information in accordance with the intra prediction mode information supplied from the intra prediction unit 114 or the information corresponding to the optimum inter prediction mode supplied from the motion disparity prediction/compensation unit 115, and adds the encoded information to the encoded data. More specifically, the motion disparity vector information, the predicted vector index, the initialized_disparity flag, a reference frame index, and the like are also encoded, and are added to the encoded data. Further, the maximum and minimum disparity values from the disparity detection unit 122 and the reference view information are also encoded, and are added to the encoded data.

The initialized_disparity flag and the maximum and minimum disparity values are included in the slice header as described above with reference to FIG. 7, and the reference view information is included in the sequence parameter set as described above with reference to FIG. 6.

In step S115, the accumulation buffer 107 accumulates the encoded data that is output from the lossless encoding unit 106. The encoded data accumulated in the accumulation buffer 107 is read where appropriate, and is transmitted to the decoding side via a transmission path.

In step S116, based on the compressed images accumulated in the accumulation buffer 107 by the processing in step S115, the rate control unit 117 controls the quantization operation rate of the quantization unit 105 so as not to cause an overflow or underflow.

When the processing in step S116 is completed, the encoding process comes to an end.

[Flow in the Inter Motion Disparity Prediction Process]

Referring now to the flowchart in FIG. 9, an example flow in the inter motion disparity prediction process to be performed in step S112 in FIG. 8 is described.

A decoded image pixel value from the decoded picture buffer 112 is supplied to the motion disparity vector search unit 131 and the predicted image generation unit 132. An original image pixel value from the screen rearrangement buffer 102 is supplied to the motion disparity vector search unit 131 and the encoding cost calculation unit 133.

In step S131, the motion disparity vector search unit 131 performs a motion disparity prediction in each inter prediction mode by using the original image pixel value from the screen rearrangement buffer 102 and the decoded image pixel value from the decoded picture buffer 112. As a result, a motion disparity vector is detected, and the motion disparity vector search unit 131 supplies the detected motion disparity vector, the reference image index used as reference, and prediction mode information, to the predicted image generation unit 132 and the encoding cost calculation unit 133.

In step S132, the predicted image generation unit 132 performs a motion disparity compensation process on the decoded image pixel value from the decoded picture buffer 112 by using the motion disparity vector from the motion disparity vector search unit 131, and generates a predicted image. This process is also performed in all the inter prediction modes.

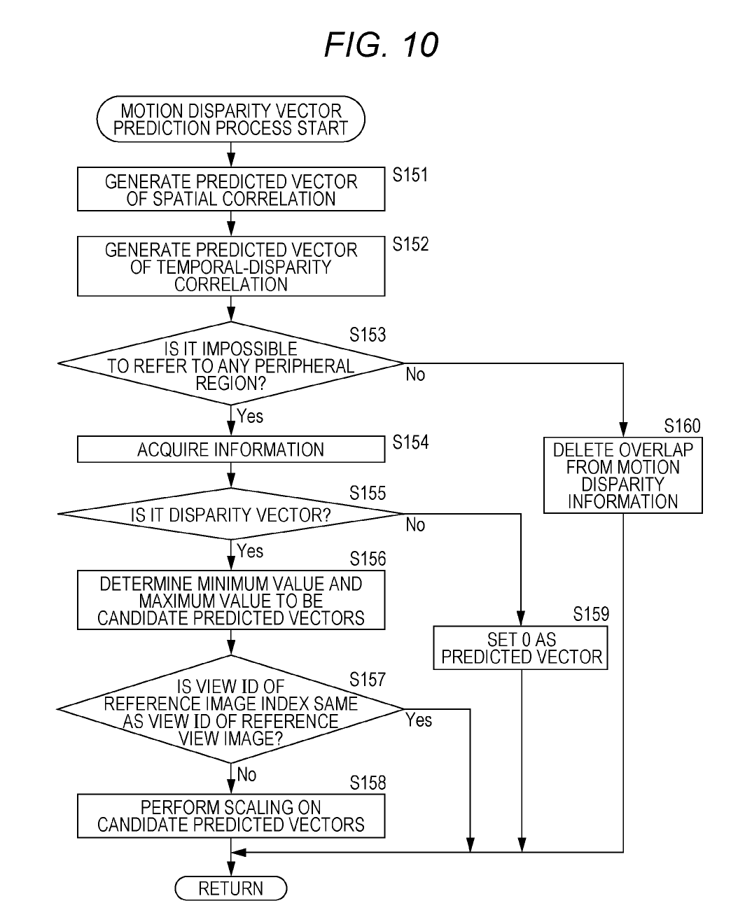

In step S133, the spatial predicted vector generation unit 136, the temporal-disparity predicted vector generation unit 137, and the predicted vector generation unit 138 perform a motion disparity vector prediction process in each inter prediction mode. This motion disparity vector prediction process will be described later with reference to FIG. 10. Through the processing in step S133, a predicted vector in each inter prediction mode is generated. The generated predicted vectors are supplied to the encoding cost calculation unit 133.

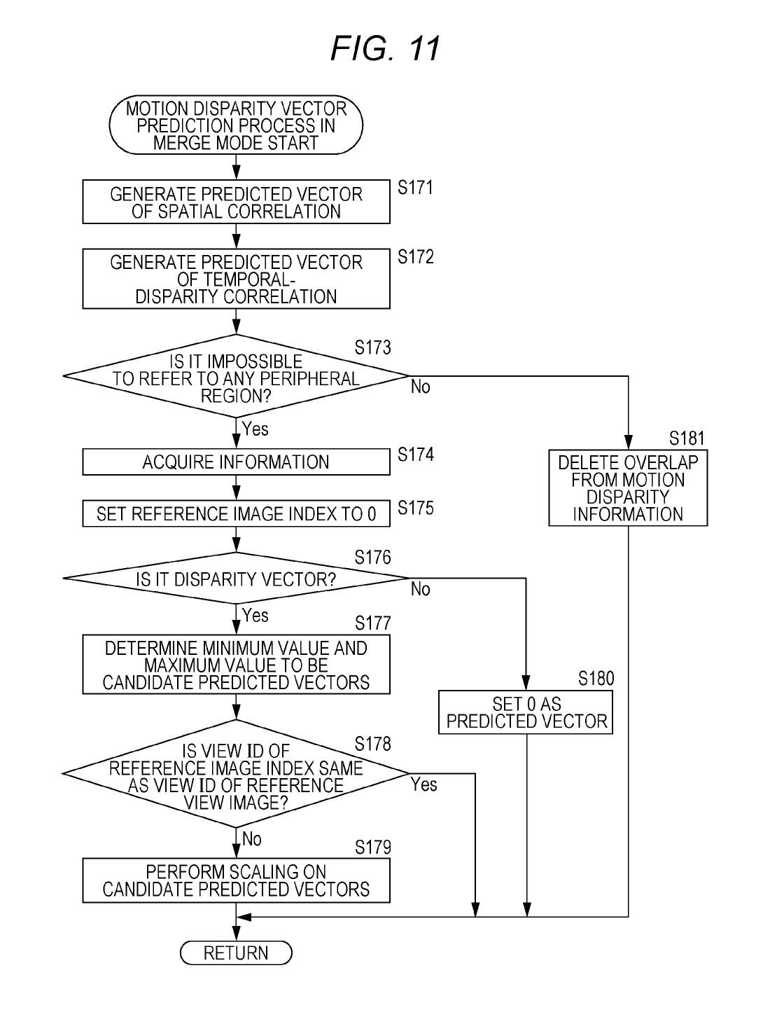

Further, in step S134, the spatial predicted vector generation unit 136, the temporal-disparity predicted vector generation unit 137, and the predicted vector generation unit 138 perform a motion disparity vector prediction process in a merge mode. This motion disparity vector prediction process in the merge mode will be described later with reference to FIG. 11. Through the processing in step S134, predicted vectors in the merge mode and a skip mode are generated. The generated predicted vectors are supplied to the encoding cost calculation unit 133.

Here, the merge mode is a mode for transmitting only the merge index indicating the predicted vector in the merge mode and the residual coefficient to the decoding side, and the skip mode is a mode for transmitting only the merge index to the decoding side. On the decoding side, the motion disparity vector of the current region is determined from the motion disparity vector of the surroundings by using the merge index.

In step S135, the encoding cost calculation unit 133 calculates encoding cost values in the respective modes (which are the respective inter prediction modes, the merge mode, and the skip mode). In the calculation of the encoding costs, the cost function in the above described expressions (4) or (5) is used, for example.

The encoding cost calculation unit 133 supplies the calculated encoding cost values, together with the information supplied from the respective components, to the mode determination unit 134.

In step S136, the mode determination unit 134 compares the encoding cost values from the encoding cost calculation unit 133 with one another, to determine an optimum inter prediction mode. The mode determination unit 134 supplies the pixel value of the predicted image in the determined optimum inter prediction mode to the selection unit 116.

In a case where more than one predicted vector is set as candidates by the processing in step S133 or S134, the encoding cost values of the candidates are determined by the processing in step S135, and a predicted vector is determined by the mode determination unit 134. Also, an encoding cost value is calculated for each slice by the processing in step S133, and the mode determination unit 134 determines whether the initialized_disparity flag is 0 or 1.

Accordingly, the mode determination unit 134 also supplies the mode information indicating the determined optimum inter prediction mode, the index of the determined predicted vector, the reference image index, the motion disparity vector information indicating the difference between the motion disparity vector and the predicted vector, to the lossless encoding unit 106. When the merge mode or the skip mode is determined, the mode determination unit 134 supplies the information about the determined mode and the merge index (the index of the predicted vector in the merge mode) to the lossless encoding unit 106. The mode determination unit 134 further supplies the value of the initialized_disparity flag to the lossless encoding unit 106 for each slice.

The mode determination unit 134 also supplies the information about the determined mode, the reference image index, and the motion disparity vector as it is, to the encoding information accumulation buffer 135.

[Flow in the Motion Disparity Vector Prediction Process]

Referring now to the flowchart in FIG. 10, an example flow in the motion disparity vector prediction process to be performed in step S133 in FIG. 9 is described.

The mode information, the reference image index, the motion disparity vector, and the like are accumulated as encoding information about the peripheral regions in the encoding information accumulation buffer 135.

The spatial predicted vector generation unit 136 acquires information, such as the mode information about the peripheral regions, the reference image index, and the motion disparity vector, from the encoding information accumulation buffer 135 if necessary. In step S151, the spatial predicted vector generation unit 136 generates a predicted vector of a spatial correlation of the current region by using the acquired information. The spatial predicted vector generation unit 136 supplies the generated predicted vector of the spatial correlation and the information about the peripheral region used in the generation to the predicted vector generation unit 138.

The temporal-disparity predicted vector generation unit 137 acquires information, such as the mode information about the peripheral regions, the reference image index, and the motion disparity vector, from the encoding information accumulation buffer 135 if necessary. In step S152, the temporal-disparity predicted vector generation unit 137 generates a predicted vector of a temporal-disparity correlation of the current region by using the acquired information. The temporal-disparity predicted vector generation unit 137 supplies the generated predicted vector of the temporal-disparity correlation and the peripheral region information used in the generation, to the predicted vector generation unit 138.

In step S153, the predicted vector generation unit 138 determines whether it is possible to refer to all the peripheral regions of the current region. When any predicted vector is not supplied from the spatial predicted vector generation unit 136 or the temporal-disparity predicted vector generation unit 137, it is determined in step S153 that there is no motion disparity information or it is not possible to refer to any of the peripheral regions, and the process then moves on to step S154.

In step S154, the predicted vector generation unit 138 acquires various kinds of necessary information. Specifically, the predicted vector generation unit 138 acquires the minimum disparity value and the maximum disparity value, and the reference view information, from the disparity detection unit 122. The predicted vector generation unit 138 also acquires the information about the reference image index of the current region from the encoding cost calculation unit 133.

In step S155, the predicted vector generation unit 138 determines whether it is a disparity vector. When the reference image indicated by the reference image index is a different view at the same time, it is determined to be a disparity vector in step S155, and the predicted vector generation unit 138 in step S156 determines the minimum disparity value and the maximum disparity value to be candidates for the predicted vector.

In step S157, the predicted vector generation unit 138 determines whether the view IDs of the reference image index and the reference view image indicated by the reference view information are the same. If the view IDs of the reference image index and the reference view image are determined to be different in step S157, the predicted vector generation unit 138 in step S158 performs scaling on each of the candidate predicted vectors in accordance with the distance of the view. The predicted vector generation unit 138 then supplies the candidate predicted vectors subjected to the scaling to the encoding cost calculation unit 133, and ends the motion disparity vector prediction process.

If the view IDs of the reference image index and the reference view image are determined to be the same in step S157, the predicted vector generation unit 138 supplies the candidate predicted vectors to the encoding cost calculation unit 133, and ends the motion disparity vector prediction process.

When the reference image indicated by the reference image index is the same view at a different time, it is determined to be a motion vector in step S155, and the process moves on to step S159. In step S159, the predicted vector generation unit 138 supplies 0 as the predicted vector to the encoding cost calculation unit 133, and ends the motion disparity vector prediction process.

In a case where it is determined in step S153 that there is motion information or it is possible to refer to one or more of the peripheral regions, on the other hand, the process moves on to step S160. If there is an overlap in the motion information, the predicted vector generation unit 138 removes the overlap in step S160. The predicted vector generation unit 138 then supplies the information other than that as the candidate predicted vectors to the encoding cost calculation unit 133, and ends the motion disparity vector prediction process.

When there is more than one candidate, the mode determination unit 134 determines one predicted vector from those candidates in accordance with encoding cost values, and supplies the index of the determined predicted vector to the lossless encoding unit 106.

[Flow in the Motion Disparity Vector Prediction Process in the Merge Mode]

Referring now to the flowchart in FIG. 11, an example flow in the motion disparity vector prediction process in the merge mode to be performed in step S134 in FIG. 9 is described.

The mode information, the reference image index, the motion disparity vector, and the like are accumulated as encoding information about the peripheral regions in the encoding information accumulation buffer 135.

The spatial predicted vector generation unit 136 acquires information, such as the mode information about the peripheral regions, the reference image index, and the motion disparity vector, from the encoding information accumulation buffer 135 if necessary. In step S171, the spatial predicted vector generation unit 136 generates a predicted vector of a spatial correlation of the current region by using the acquired information. The spatial predicted vector generation unit 136 supplies the generated predicted vector of the spatial correlation and the information about the peripheral region used in the generation to the predicted vector generation unit 138.

The temporal-disparity predicted vector generation unit 137 acquires information, such as the mode information about the peripheral regions, the reference image index, and the motion disparity vector, from the encoding information accumulation buffer 135 if necessary. In step S172, the temporal-disparity predicted vector generation unit 137 generates a predicted vector of a temporal-disparity correlation of the current region by using the information. The temporal-disparity predicted vector generation unit 137 supplies the generated predicted vector of the temporal-disparity correlation and the peripheral region information used in the generation, to the predicted vector generation unit 138.

In step S173, the predicted vector generation unit 138 determines whether it is possible to refer to all the peripheral regions. When any predicted vector information is not supplied from the spatial predicted vector generation unit 136 or the temporal-disparity predicted vector generation unit 137, it is determined in step S173 that there is no motion information or it is not possible to refer to any of the peripheral regions, and the process then moves on to step S174.

In step S174, the predicted vector generation unit 138 acquires various kinds of necessary information. Specifically, the predicted vector generation unit 138 acquires the minimum disparity value and the maximum disparity value, and the reference view information, from the disparity detection unit 122.

In step S175, the predicted vector generation unit 138 sets the reference image index to 0.

In step S176, the predicted vector generation unit 138 determines whether it is a disparity vector. When the reference image indicated by the reference image index is a different view at the same time, it is determined to be a disparity vector in step S176, and the predicted vector generation unit 138 in step S177 determines the minimum disparity value and the maximum disparity value to be candidates for the predicted vector.

In step S178, the predicted vector generation unit 138 determines whether the view IDs of the reference image index and the reference view image indicated by the reference view information are the same. If the view IDs of the reference image index and the reference view image are determined to be different in step S178, the predicted vector generation unit 138 in step S179 performs scaling on each of the candidate predicted vectors in accordance with the distance of the view. The predicted vector generation unit 138 then supplies the candidate predicted vectors subjected to the scaling to the encoding cost calculation unit 133, and ends the motion disparity vector prediction process.

If the view IDs of the reference image index and the reference view image are determined to be the same in step S178, the predicted vector generation unit 138 supplies the candidate predicted vectors to the encoding cost calculation unit 133, and ends the motion disparity vector prediction process in the merge mode.

When the reference image indicated by the reference image index is the same view at a different time, it is determined to be a motion vector in step S176, and the process moves on to step S180. In step S180, the predicted vector generation unit 138 supplies 0 as the predicted vector to the encoding cost calculation unit 133, and ends the motion disparity vector prediction process in the merge mode.

In a case where it is determined in step S173 that there is motion information or it is possible to refer to one or more of the peripheral regions, on the other hand, the process moves on to step S181. If there is an overlap in the motion information, the predicted vector generation unit 138 removes the overlap in step S181. The predicted vector generation unit 138 then supplies the information other than that as the candidate predicted vectors to the encoding cost calculation unit 133, and ends the motion disparity vector prediction process.

When there is more than one candidate, the mode determination unit 134 determines one predicted vector from those candidates in accordance with encoding cost values, and supplies the index of the determined predicted vector as the merge index to the lossless encoding unit 106.

As described above, in a case where it is not possible to refer to any of the peripheral regions when a predicted vector of a disparity vector is to be determined, the minimum disparity value or the maximum disparity value is set as the predicted vector. As a result, encoding efficiency is made higher than in a case where the previous predicted vector is set to a 0 vector.

### 3. Second Embodiment

### [Image Decoding Device]

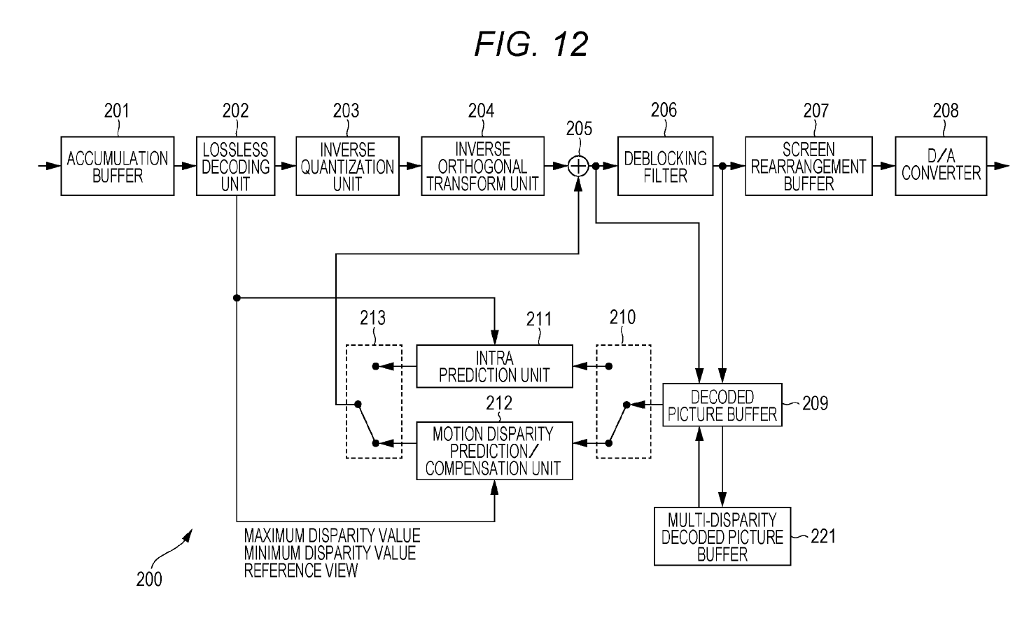

FIG. 12 shows the structure of an embodiment of an image decoding device as an image processing device to which the present disclosure is applied. The image decoding device 200 shown in FIG. 12 is a decoding device that is compatible with the image encoding device 100 shown in FIG. 1.

Data encoded by the image encoding device 100 is transmitted to the image decoding device 200 compatible with the image encoding device 100 via a predetermined transmission path, and is then decoded.

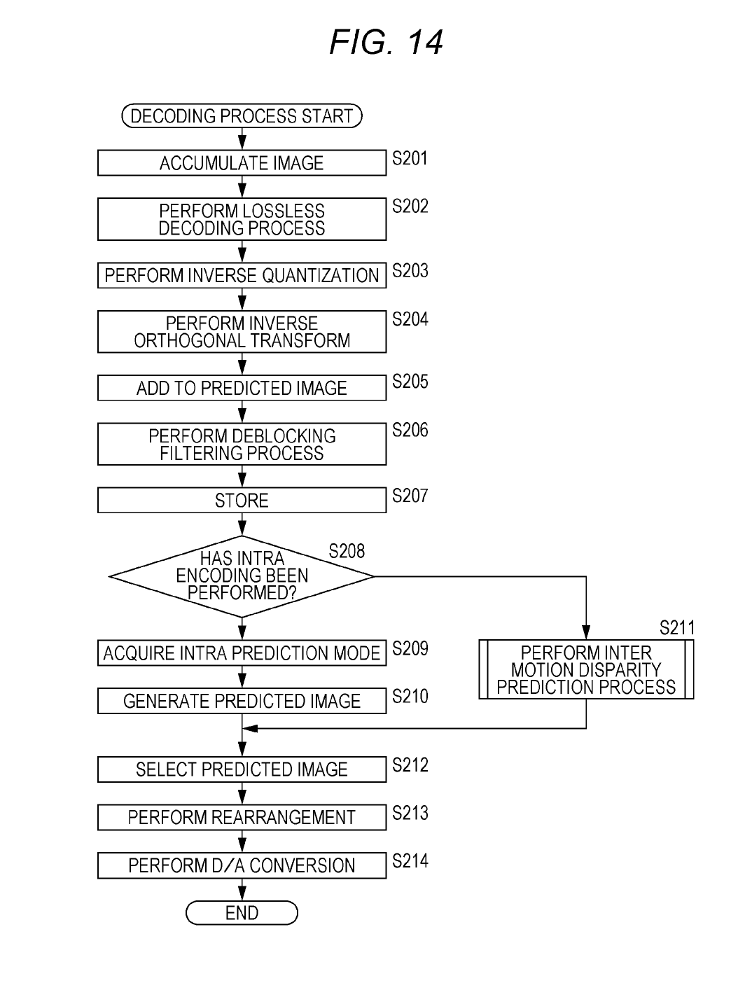

As shown in FIG. 14, the image decoding device 200 includes an accumulation buffer 201, a lossless decoding unit 202, an inverse quantization unit 203, an inverse orthogonal transform unit 204, an arithmetic operation unit 205, a deblocking filter 206, a screen rearrangement buffer 207, and a D/A converter 208. The image decoding device 200 also includes a decoded picture buffer 209, a selection unit 210, an intra prediction unit 211, a motion disparity prediction/compensation unit 212, and a selection unit 213.

The image decoding device 200 further includes a multi-view decoded picture buffer 221.

The accumulation buffer 201 accumulates transmitted encoded data. The encoded data has been encoded by the image encoding device 100. The lossless decoding unit 202 decodes the encoded data read from the accumulation buffer 201 at a predetermined time, by a method corresponding to the encoding method used by the lossless encoding unit 106 shown in FIG. 2.

The inverse quantization unit 203 inversely quantizes the coefficient data (the quantized coefficient) decoded by the lossless decoding unit 202, by a method corresponding to the quantization method used by the quantization unit 105 shown in FIG. 2. Specifically, using a quantization parameter supplied from the image encoding device 100, the inverse quantization unit 203 inversely quantizes the quantized coefficient by the same method as the method used by the inverse quantization unit 108 shown in FIG. 2.

The inverse quantization unit 203 supplies the inversely-quantized coefficient data, or an orthogonal transform coefficient, to the inverse orthogonal transform unit 204. The inverse quantization unit 203 also supplies the quantization parameter used in the inverse quantization to the deblocking filter 206. The inverse orthogonal transform unit 204 subjects the orthogonal transform coefficient to an inverse orthogonal transform by a method corresponding to the orthogonal transform method used by the orthogonal transform unit 104 shown in FIG. 2, and obtains decoded residual error data corresponding to the residual error data prior to the orthogonal transform performed by the image encoding device 100.

The decoded residual error data obtained through the inverse orthogonal transform is supplied to the arithmetic operation unit 205. A predicted image is also supplied to the arithmetic operation unit 205 from the intra prediction unit 211 or the motion disparity prediction/compensation unit 212 via the selection unit 213.

The arithmetic operation unit 205 adds the decoded residual error data to the predicted image, and obtains decoded image data corresponding to the image data prior to the subtraction performed by the arithmetic operation unit 103 of the image encoding device 100. The arithmetic operation unit 205 supplies the decoded image data to the deblocking filter 206.

The deblocking filter 206 basically has the same structure as the deblocking filter 111 of the image encoding device 100. The deblocking filter 206 removes block distortions from the decoded image by performing a deblocking filtering operation where necessary.

The screen rearrangement buffer 207 performs image rearrangement. Specifically, the frame sequence rearranged in the encoding order by the screen rearrangement buffer 102 shown in FIG. 2 is rearranged in the original displaying order. The D/A converter 208 performs a D/A conversion on the images supplied from the screen rearrangement buffer 207, and outputs the converted images to a display (not shown) to display the images.

The output of the deblocking filter 206 is further supplied to the decoded picture buffer 209.

The decoded picture buffer 209, the selection unit 210, the intra prediction unit 211, the motion disparity prediction/compensation unit 212, and the selection unit 213 correspond to the decoded picture buffer 112, the selection unit 113, the intra prediction unit 114, the motion disparity prediction/compensation unit 115, and the selection unit 116 of the image encoding device 100, respectively.

A decoded image of an encoding viewpoint from the deblocking filter 206 or a decoded image of a viewpoint other than the encoding viewpoint from the multi-view decoded picture buffer 221 is accumulated in the decoded picture buffer 209.

The selection unit 210 reads, from the decoded picture buffer 209, an image to be inter-processed and an image to be referred to, and supplies the images to the motion disparity prediction/compensation unit 212. The selection unit 210 also reads an image to be used for intra predictions from the decoded picture buffer 209, and supplies the image to the intra prediction unit 211.

Information that has been obtained by decoding the header information and indicates an intra prediction mode or the like is supplied, where appropriate, from the lossless decoding unit 202 to the intra prediction unit 211. Based on the information, the intra prediction unit 211 generates a predicted image from the reference image obtained from the decoded picture buffer 209, and supplies the generated predicted image to the selection unit 213.

The information obtained by decoding the header information (prediction mode information, motion disparity vector information indicating a difference between a motion disparity vector and a predicted vector, a reference frame index, a flag, respective parameters, and the like) is supplied from the lossless decoding unit 202 to the motion disparity prediction/compensation unit 212. Further, the minimum disparity value and the maximum disparity value, and reference view information are supplied from the lossless decoding unit 202 to the motion disparity prediction/compensation unit 212.

Based on the information supplied from the lossless decoding unit 202, the motion disparity prediction/compensation unit 212 generates a predicted vector by using the motion disparity vector of a peripheral region located in the vicinity of the current region. When a predicted vector of a disparity vector is to be determined, but it is not possible to refer to any of the motion disparity vectors of the peripheral regions, the motion disparity prediction/compensation unit 212 sets the minimum disparity value or the maximum disparity value supplied from the lossless decoding unit 202 as the predicted vector.

Using the generated predicted vector and the motion disparity vector information, the motion disparity prediction/compensation unit 212 reconstructs a motion disparity vector, generates a predicted image from a reference image acquired from the decoded picture buffer 209, and supplies the generated predicted image to the selection unit 213.

The selection unit 213 selects the predicted image generated by the motion disparity prediction/compensation unit 212 or the predicted image generated by the intra prediction unit 211, and supplies the selected predicted image to the arithmetic operation unit 205.

The multi-view decoded picture buffer 221 replaces the decoded image of an encoding viewpoint accumulated in the decoded picture buffer 209 with a decoded image of a viewpoint other than the encoding viewpoint, in accordance with the current view (viewpoint).

[Example Structure of the Motion Disparity Prediction/Compensation Unit]

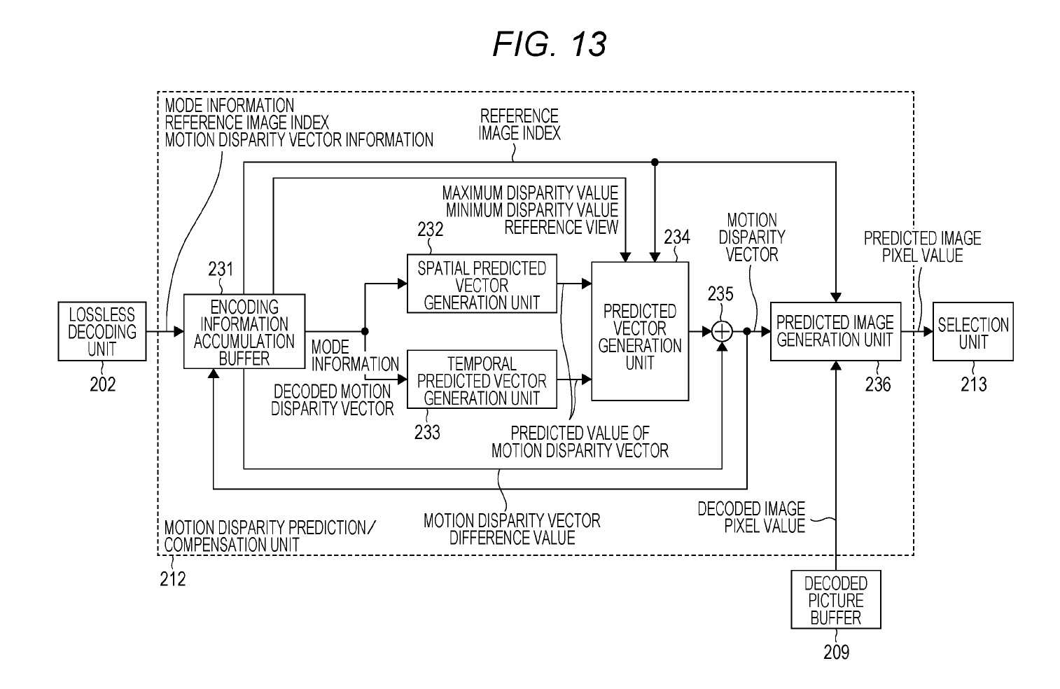

Next, the respective components of the image decoding device 200 are described. FIG. 13 is a block diagram showing an example structure of the motion disparity prediction/compensation unit 212. The example illustrated in FIG. 13 shows only the flow of principal information.

In the example illustrated in FIG. 13, the motion disparity prediction/compensation unit 212 is designed to include an encoding information accumulation buffer 231, a spatial predicted vector generation unit 232, a temporal-disparity predicted vector generation unit 233, a predicted vector generation unit 234, an arithmetic operation unit 235, and a predicted image generation unit 236. Specifically, the spatial predicted vector generation unit 232, the temporal-disparity predicted vector generation unit 233, and the predicted vector generation unit 234 correspond to the spatial predicted vector generation unit 136, the temporal-disparity predicted vector generation unit 137, and the predicted vector generation unit 138 shown in FIG. 5.

The mode information about the current region, the reference image index, the predicted vector index, and the motion disparity vector information indicating the difference between the motion disparity vector and the predicted vector are supplied from the lossless decoding unit 202 to the encoding information accumulation buffer 231. Also, an initialized_disparity flag, the minimum disparity value, and the maximum disparity value, which are obtained from a slice header, and reference view information obtained from a sequence parameter set are supplied from the lossless decoding unit 202 to the encoding information accumulation buffer 231.

Further, a peripheral region motion disparity vector reconstructed by the arithmetic operation unit 235 (hereinafter also referred to as the decoded motion disparity vector) is supplied to the encoding information accumulation buffer 231.

The spatial predicted vector generation unit 232 acquires information such as the mode information about the peripheral regions, the reference image index, and the decoded motion disparity vector from the encoding information accumulation buffer 231 if necessary, and generates a predicted vector of a spatial correlation of the current region by using those pieces of information. The spatial predicted vector generation unit 232 supplies the generated predicted vector of the spatial correlation and the information about the peripheral region used in the generation to the predicted vector generation unit 234.

The temporal-disparity predicted vector generation unit 233 acquires information, such as the mode information about the peripheral regions, the reference image index, and the decoded motion disparity vector, from the encoding information accumulation buffer 231 if necessary. The temporal-disparity predicted vector generation unit 233 generates a predicted vector of a temporal-disparity correlation of the current region by using those pieces of information. The temporal-disparity predicted vector generation unit 233 supplies the generated predicted vector of the temporal-disparity correlation and the peripheral region information used in the generation, to the predicted vector generation unit 234.

The predicted vector generation unit 234 acquires, from the encoding information accumulation buffer 231, the reference image index, the predicted vector index, the initialized_disparity flag, the minimum disparity value and the maximum disparity value, and the reference view information. The predicted vector generation unit 234 acquires the generated predicted vectors and the peripheral region information from the spatial predicted vector generation unit 232 and the temporal-disparity predicted vector generation unit 233.

By referring to the acquired information, the predicted vector generation unit 234 supplies the predicted vector from the spatial predicted vector generation unit 232 or the temporal-disparity predicted vector generation unit 233, a 0 vector, or a predicted vector determined from the minimum disparity value or the maximum disparity value, to the arithmetic operation unit 235. Specifically, when a predicted vector of a disparity vector is to be determined, but it is not possible to refer to any of the motion disparity vectors of the peripheral regions, the predicted vector generation unit 234 sets the minimum disparity value or the maximum disparity value supplied from the lossless decoding unit 202 as the predicted vector.

The arithmetic operation unit 235 acquires the motion disparity vector information (the difference value with respect to the motion disparity vector) from the encoding information accumulation buffer 231, and reconstructs the motion disparity vector by adding the motion disparity vector information to the predicted vector supplied from the predicted vector generation unit 234. The arithmetic operation unit 235 supplies the reconstructed motion disparity vector to the predicted image generation unit 236 and the encoding information accumulation buffer 231.

The predicted image generation unit 236 acquires, from the decoded picture buffer 209, the pixel value of the decoded image indicated by the reference image index supplied from the encoding information accumulation buffer 231, and generates a predicted image by using the motion disparity vector supplied from the arithmetic operation unit 235. The predicted image generation unit 236 supplies the pixel value of the generated predicted image to the selection unit 213.

[Flow in a Decoding Process]

Next, the flow in each process to be performed by the above described image decoding device 200 is described. Referring first to the flowchart shown in FIG. 14, an example flow in a decoding operation is described.

When the decoding operation is started, the accumulation buffer 201 accumulates transmitted encoded data in step S201. In step S202, the lossless decoding unit 202 decodes the encoded data supplied from the accumulation buffer 201. Specifically, I-pictures, P-pictures, and B-pictures encoded by the lossless encoding unit 106 shown in FIG. 2 are decoded.

At this point, prediction mode information (an intra prediction mode, an inter prediction mode, a merge mode, a skip mode, or the like) is also decoded. Further, the motion disparity vector information, the reference image index, the predicted vector index, the initialized_disparity flag, the minimum disparity value and the maximum disparity value, and information corresponding to an inter prediction mode such as reference view information are also decoded.

In a case where the prediction mode information is intra prediction mode information, the prediction mode information is supplied to the intra prediction unit 211. In a case where the prediction mode information is inter prediction mode information, a merge mode, or a skip mode, the prediction mode information and the information according to the inter prediction mode are supplied to the motion disparity prediction/compensation unit 212.

In step S203, the inverse quantization unit 203 inversely quantizes a quantized orthogonal transform coefficient obtained as a result of the decoding by the lossless decoding unit 202. In step S204, the inverse orthogonal transform unit 204 performs an inverse orthogonal transform on the orthogonal transform coefficient obtained through the inverse quantization performed by the inverse quantization unit 203, by a method corresponding to the method used by the orthogonal transform unit 104 shown in FIG. 2. As a result, the difference information corresponding to the input to the orthogonal transform unit 104 (or the output from the arithmetic operation unit 103) shown in FIG. 2 is decoded.

In step S205, the arithmetic operation unit 205 adds a predicted image to the difference information obtained by the processing in step S204. In this manner, the original image data is decoded.

In step S206, the deblocking filter 206 performs filtering on the decoded image obtained by the processing in step S205, where appropriate. As a result, block distortions are properly removed from the decoded image.

In step S207, the decoded picture buffer 209 stores the decoded images subjected to the filtering.

In step S208, the intra prediction unit 211 or the motion disparity prediction/compensation unit 212 determines whether intra encoding has been performed in accordance with the prediction mode information supplied from the lossless decoding unit 202.

If it is determined in step S208 that intra encoding has been performed, the intra prediction unit 211 in step S209 acquires the intra prediction mode from the lossless decoding unit 202. In step S210, the intra prediction unit 211 generates a predicted image in accordance with the intra prediction mode acquired in step S209. The intra prediction unit 211 supplies the generated predicted image to the selection unit 213.

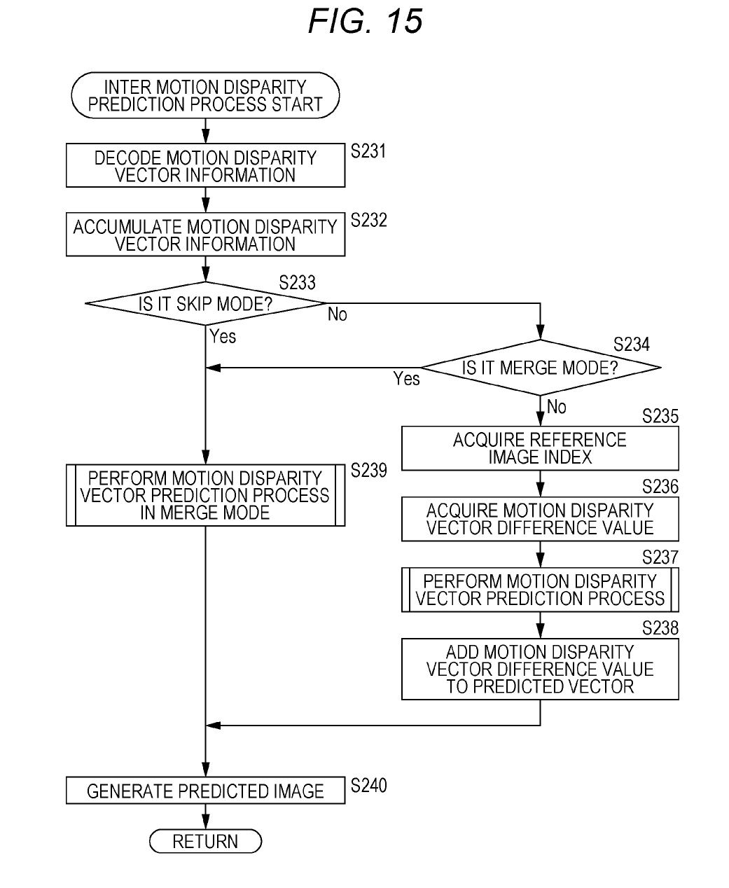

If it is determined in step S208 that the prediction mode information is an inter prediction mode, a merge mode, a skip mode, or the like, and intra encoding has not been performed, the process moves on to step S211. In step S211, the motion disparity prediction/compensation unit 212 performs an inter motion disparity prediction process. This inter motion disparity prediction process will be described later with reference to FIG. 15.

Based on the information supplied from the lossless decoding unit 202, a predicted vector is generated by using the motion disparity vector of a peripheral region located in the vicinity of the current region in the processing in step S211. When a predicted vector of a disparity vector is to be determined, but it is not possible to refer to any of the motion disparity vectors of the peripheral regions, the motion disparity prediction/compensation unit 212 sets the minimum disparity value or the maximum disparity value supplied from the lossless decoding unit 202 as the predicted vector.

With the use of the generated predicted vector and the motion disparity vector information (a difference value), the motion disparity vector is reconstructed, a predicted image is generated from the reference image acquired from the decoded picture buffer 209, and the generated predicted image is supplied to the selection unit 213.

In step S212, the selection unit 213 selects a predicted image. Specifically, the predicted image generated by the intra prediction unit 211, or the predicted image generated by the motion disparity prediction/compensation unit 212 is supplied to the selection unit 213. The selection unit 213 selects the supplied predicted image, and supplies the predicted image to the arithmetic operation unit 205. This predicted image is added to the difference information by the processing in step S205.

In step S213, the screen rearrangement buffer 207 rearranges the frames of the decoded image data. Specifically, in the decoded image data, the order of frames rearranged for encoding by the screen rearrangement buffer 102 of the image encoding device 100 (FIG. 2) is rearranged in the original displaying order.

In step S214, the D/A converter 208 performs a D/A conversion on the decoded image data having the frames rearranged by the screen rearrangement buffer 207. The decoded image data is output to a display (not shown), and the image is displayed.

[Flow in the Inter Motion Disparity Prediction Process]

Referring now to the flowchart in FIG. 15, an example flow in the inter motion disparity prediction process to be performed in step S211 in FIG. 14 is described.

The decoded mode information about the current region, the reference image index, the motion disparity vector information, and the predicted vector index are supplied from the lossless decoding unit 202. The initialized_disparity flag, the minimum disparity value and the maximum disparity value, and the reference view information are also supplied, if necessary. The encoding information accumulation buffer 231 acquires the motion disparity vector information and the like in step S231, and accumulates those pieces of information in step S232.

By referring to the mode information accumulated in the encoding information accumulation buffer 231, the spatial predicted vector generation unit 232 and the temporal-disparity predicted vector generation unit 233 in step S233 determine whether the mode of the current region is a skip mode.

If the mode is determined not to be a skip mode in step S233, the spatial predicted vector generation unit 232 and the temporal-disparity predicted vector generation unit 233 in step S234 determine whether the mode of the current region is a merge mode. If the mode is determined not to be a merge mode in step S234, the process moves on to step S235.

In step S235, the predicted vector generation unit 234 and the predicted image generation unit 236 acquire the reference image index of the current region accumulated in the encoding information accumulation buffer 231.

In step S236, the arithmetic operation unit 235 acquires the motion disparity vector information, which is the difference value with respect to the motion disparity vector of the current region accumulated in the encoding information accumulation buffer 231.

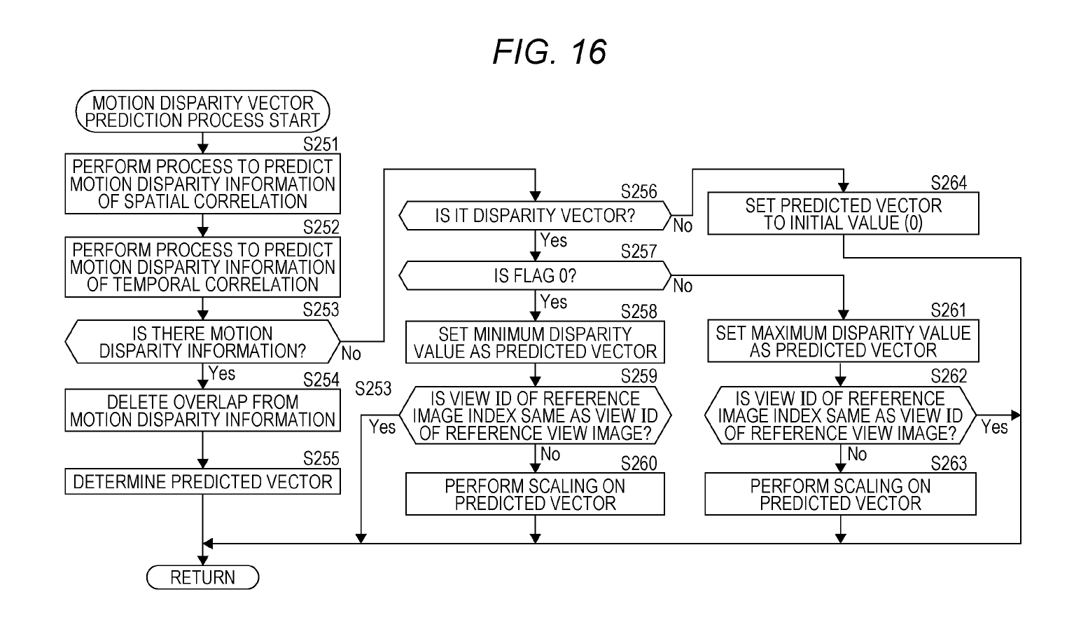

In step S237, the spatial predicted vector generation unit 232, the temporal-disparity predicted vector generation unit 233, and the predicted vector generation unit 234 perform a motion disparity vector prediction process. This motion disparity vector prediction process will be described later in detail with reference to FIG. 16.

Through the processing in step S237, a predicted vector is generated. In a case where a disparity vector is to be generated, but it is not possible to refer to any peripheral region, a predicted vector is generated by using the maximum disparity value or the minimum disparity value obtained from the slice header. The predicted vector generation unit 234 outputs the generated predicted vector to the arithmetic operation unit 235.

In step S238, the arithmetic operation unit 235 adds the difference value with respect to the motion disparity vector obtained in step S236, to the predicted vector generated in step S237. As a result, the motion disparity vector is reconstructed. The reconstructed motion disparity vector is supplied to the predicted image generation unit 236, and the process moves on to step S240.

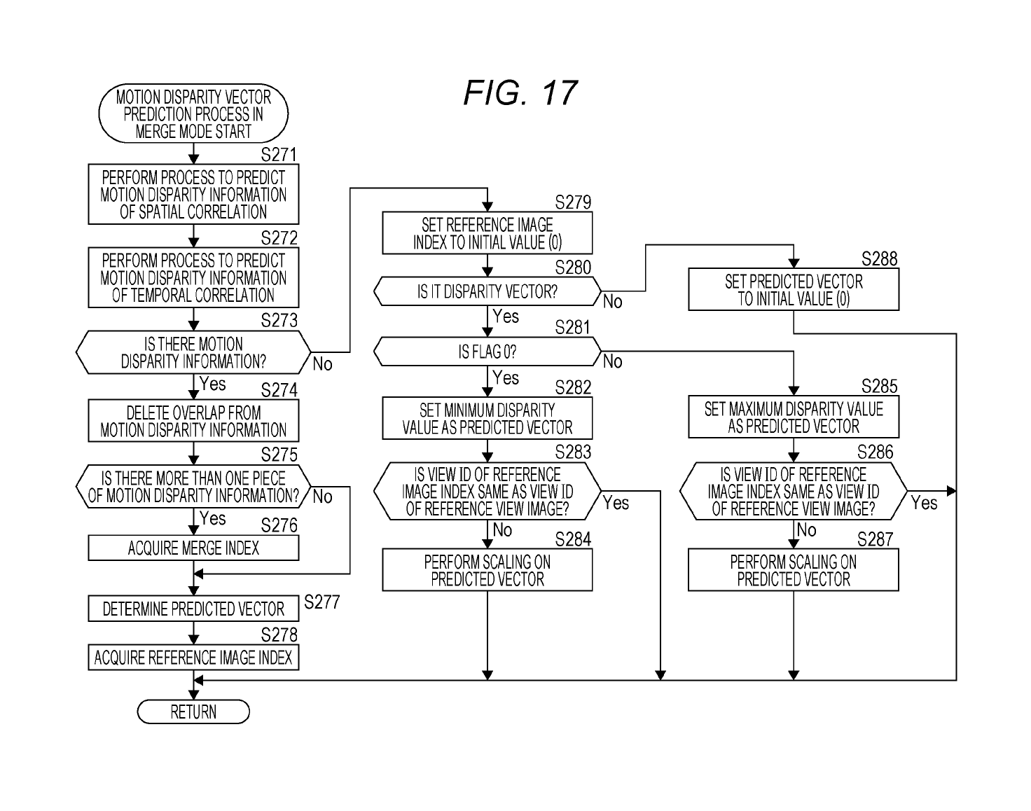

If the mode is determined to be a skip mode in step S233, or if the mode is determined to be a merge mode in step S234, on the other hand, the process moves on to step S239. In step S239, the spatial predicted vector generation unit 232, the temporal-disparity predicted vector generation unit 233, and the predicted vector generation unit 234 perform a motion disparity vector prediction process in the merge mode. This motion disparity vector prediction process in the merge mode will be described later in detail with reference to FIG. 17.

Through the processing in step S237, a predicted vector in the merge mode is generated. In a case where a disparity vector is to be generated, but it is not possible to refer to any peripheral region, a predicted vector is generated by using the maximum disparity value or the minimum disparity value obtained from the slice header. The predicted vector generation unit 234 supplies the generated predicted vector and the reference image index to the predicted image generation unit 236 via the arithmetic operation unit 235.

In step S240, the predicted image generation unit 236 generates a predicted image. If the mode is not a merge mode, the predicted image generation unit 236 reads, from the decoded picture buffer 209, the decoded image pixel value indicated by the reference image index supplied from the encoding information accumulation buffer 231. The predicted image generation unit 236 then generates a predicted image by using the decoded image pixel value and the motion disparity vector.

If the mode is a merge mode, the predicted image generation unit 236 reads, from the decoded picture buffer 209, the decoded image pixel value indicated by the reference image index supplied from the predicted vector generation unit 234. The predicted image generation unit 236 then generates a predicted image by using the decoded image pixel value and the generated predicted vector.

The pixel value of the predicted image generated in step S240 is output to the selection unit 213, and the inter motion disparity prediction process is then ended.

[Flow in the Motion Disparity Vector Prediction Process]

Referring now to the flowchart in FIG. 16, an example flow in the motion disparity vector prediction process to be performed in step S237 in FIG. 15 is described.

The spatial predicted vector generation unit 232 acquires information, such as the mode information about the peripheral regions, the reference image index, and the decoded motion disparity vector, from the encoding information accumulation buffer 231 if necessary. In step S251, the spatial predicted vector generation unit 232 generates a predicted vector of a spatial correlation of the current region by using the acquired information. The spatial predicted vector generation unit 232 supplies the generated predicted vector of the spatial correlation and the information about the peripheral region used in the generation to the predicted vector generation unit 234.

The temporal-disparity predicted vector generation unit 233 acquires information, such as the mode information about the peripheral regions, the reference image index, and the decoded motion disparity vector, from the encoding information accumulation buffer 231 if necessary. In step S252, the temporal-disparity predicted vector generation unit 233 generates a predicted vector of a temporal-disparity correlation of the current region by using the acquired information. The temporal-disparity predicted vector generation unit 233 supplies the generated predicted vector of the temporal-disparity correlation and the peripheral region information used in the generation, to the predicted vector generation unit 234.

In step S253, the predicted vector generation unit 234 determines whether there is motion disparity information. In a case where the predicted vector from the spatial predicted vector generation unit 232 or the predicted vector from the temporal-disparity predicted vector generation unit 233 is supplied, the predicted vector generation unit 234 in step S253 determines that there is motion disparity information, and the process moves on to step S254.

In step S254, the predicted vector generation unit 234 deletes an overlap in the motion disparity information, if any, from the predicted vector from the spatial predicted vector generation unit 232 or the predicted vector from the temporal-disparity predicted vector generation unit 233.

In step S255, the predicted vector generation unit 234 determines a predicted vector. In a case where there is more than one predicted vector, the predicted vector generation unit 234 determines the predicted vector to be the one corresponding to the predicted vector index accumulated in the encoding information accumulation buffer 231. The determined predicted vector is output to the arithmetic operation unit 235, and the motion disparity vector prediction process is ended.

If it is determined in step S253 that there is no motion disparity information, on the other hand, the process moves on to step S256. In step S256, the predicted vector generation unit 234 determines whether the predicted vector is a disparity vector. In a case where the reference image indicated by the reference image index of the current region supplied from the encoding information accumulation buffer 231 is an image of a different view from the current image at the same time as the current image, the predicted vector is determined to be a disparity vector in step S256, and the process moves on to step S257.

In step S257, the predicted vector generation unit 234 determines whether the initialized_disparity flag, which is acquired from the slice header and is accumulated in the encoding information accumulation buffer 231, is 0.

If the initialized_disparity flag is determined to be 0 in step S257, the process moves on to step S258. In step S258, the predicted vector generation unit 234 sets the value of minimum_disparity obtained from the slice header, or the minimum disparity value, as the predicted vector.

Further, in step S259, the predicted vector generation unit 234 determines whether the view ID of the reference image index and the view ID of the reference view image indicated by the reference view information are the same. If the view ID of the reference image index and the view ID of the reference view image are determined to be the same in step S259, the processing in step S260 is skipped, and the motion disparity vector generation process is ended. That is, the predicted vector determined in step 5258 is supplied to the arithmetic operation unit 235 in this case.

If the view ID of the reference image index and the view ID of the reference view image are determined to be different in step S259, the predicted vector generation unit 234 in step S260 performs scaling on the predicted vector determined in step S258. Specifically, the predicted vector generation unit 234 supplies the value obtained by performing scaling on the minimum disparity value in accordance with the viewpoint distance of the view image as the predicted vector to the arithmetic operation unit 235, and the motion disparity vector generation process is ended.

If the initialized_disparity flag is determined to be 1 in step S257, the process moves on to step S261. In step S261, the predicted vector generation unit 234 sets the value of maximum_disparity obtained from the slice header, or the maximum disparity value, as the predicted vector.

Likewise, in step S262, the predicted vector generation unit 234 determines whether the view ID of the reference image index and the view ID of the reference view image indicated by the reference view information are the same. If the view ID of the reference image index and the view ID of the reference view image are determined to be the same in step S262, the processing in step S263 is skipped, and the motion disparity vector generation process is ended. That is, the predicted vector determined in step S261 is supplied to the arithmetic operation unit 235 in this case.

If the view ID of the reference image index and the view ID of the reference view image are determined to be different in step S262, the predicted vector generation unit 234 in step S263 performs scaling on the predicted vector determined in step S261. Specifically, the predicted vector generation unit 234 supplies the value obtained by performing scaling on the minimum disparity value in accordance with the viewpoint distance of the view image as the predicted vector to the arithmetic operation unit 235, and the motion disparity vector generation process is ended.

In a case where the reference image indicated by the reference image index of the current region supplied from the encoding information accumulation buffer 231 is an image of the same view as the current image at a different time from the current image, on the other hand, the predicted vector is determined not to be a disparity vector in step S256, and the process moves on to step S264. In step S264, the predicted vector generation unit 234 sets the predicted vector to the initial value (0). Specifically, the predicted vector generation unit 234 supplies the 0 vector as the predicted vector to the arithmetic operation unit 235 in step S264, and the motion disparity vector generation process is then ended.

[Flow in the Motion Disparity Vector Prediction Process in the Merge Mode]

Referring now to the flowchart in FIG. 17, an example flow in the motion disparity vector prediction process in the merge mode to be performed in step S239 in FIG. 15 is described.

The spatial predicted vector generation unit 232 acquires information, such as the mode information about the peripheral regions, the reference image index, and the decoded motion disparity vector, from the encoding information accumulation buffer 231 if necessary. In step S271, the spatial predicted vector generation unit 232 generates a predicted vector of a spatial correlation of the current region by using the acquired information. The spatial predicted vector generation unit 232 supplies the generated predicted vector of the spatial correlation and the information about the peripheral region used in the generation to the predicted vector generation unit 234.

The temporal-disparity predicted vector generation unit 233 acquires information, such as the mode information about the peripheral regions, the reference image index, and the decoded motion disparity vector, from the encoding information accumulation buffer 231 if necessary. In step S272, the temporal-disparity predicted vector generation unit 233 generates a predicted vector of a temporal-disparity correlation of the current region by using the acquired information. The temporal-disparity predicted vector generation unit 233 supplies the generated predicted vector of the temporal-disparity correlation and the peripheral region information used in the generation, to the predicted vector generation unit 234.

In step S273, the predicted vector generation unit 234 determines whether there is motion disparity information. In a case where the predicted vector from the spatial predicted vector generation unit 232 or the predicted vector from the temporal-disparity predicted vector generation unit 233 is supplied, the predicted vector generation unit 234 in step S273 determines that there is motion disparity information, and the process moves on to step S274.

In step S274, the predicted vector generation unit 234 deletes an overlap in the motion disparity information, if any, from the predicted vector from the spatial predicted vector generation unit 232 or the predicted vector from the temporal-disparity predicted vector generation unit 233.

In step S275, the predicted vector generation unit 234 determines whether there is more than one piece of motion disparity information. If it is determined in step S275 that there is more than one piece of motion disparity information, the predicted vector generation unit 234 in step S276 acquires the merge index from the encoding information accumulation buffer 231. The merge index is the information indicating the index of the predicted vector in the merge mode.

If it is determined in step S275 that there is no more than one piece of motion disparity information, or that there is one piece of motion disparity information, step S276 is skipped.

In step S277, the predicted vector generation unit 234 determines a predicted vector. Specifically, the motion disparity information indicated by the merge index among the pieces of motion disparity information is determined to be the predicted vector. If there is only one piece of motion disparity information, on the other hand, the one piece of motion disparity information is determined to be the predicted vector.

In step S278, the predicted vector generation unit 234 acquires the reference image index used as reference by the motion disparity information determined to be the predicted vector, and supplies the predicted vector and the reference image index to the arithmetic operation unit 235. After that, the motion disparity vector prediction process in the merge mode is ended.

If it is determined in step S273 that there is no motion disparity information, on the other hand, the process moves on to step S279. In step S279, the predicted vector generation unit 234 sets the reference image index to the initial value (0).

In step S280, the predicted vector generation unit 234 determines whether the predicted vector is a disparity vector. In a case where the reference image indicated by the reference image index is an image of a different view from the current image at the same time as the current image, the predicted vector is determined to be a disparity vector in step S280, and the process moves on to step S281.

In step S281, the predicted vector generation unit 234 determines whether the initialized_disparity flag, which is acquired from the slice header and is accumulated in the encoding information accumulation buffer 231, is 0.

If the initialized_disparity flag is determined to be 0 in step S281, the process moves on to step S282. In step S282, the predicted vector generation unit 234 sets the value of minimum_disparity obtained from the slice header, or the minimum disparity value, as the predicted vector.

Further, in step S283, the predicted vector generation unit 234 determines whether the view ID of the reference image index and the view ID of the reference view image indicated by the reference view information are the same. If the view ID of the reference image index and the view ID of the reference view image are determined to be the same in step S283, the processing in step S284 is skipped, and the motion disparity vector generation process is ended. That is, the predicted vector determined in step S282 is supplied to the arithmetic operation unit 235 in this case.

If the view ID of the reference image index and the view ID of the reference view image are determined to be different in step S283, the predicted vector generation unit 234 in step S284 performs scaling on the predicted vector determined in step S282. Specifically, the predicted vector generation unit 234 supplies the value obtained by performing scaling on the minimum disparity value in accordance with the viewpoint distance of the view image as the predicted vector to the arithmetic operation unit 235, and the motion disparity vector generation process is ended.

If the initialized_disparity flag is determined to be 1 in step S281, the process moves on to step S285. In step S285, the predicted vector generation unit 234 sets the value of maximum_disparity obtained from the slice header, or the maximum disparity value, as the predicted vector.

Likewise, in step S286, the predicted vector generation unit 234 determines whether the view ID of the reference image index and the view ID of the reference view image indicated by the reference view information are the same. If the view ID of the reference image index and the view ID of the reference view image are determined to be the same in step S286, the processing in step S287 is skipped, and the motion disparity vector generation process is ended. That is, the predicted vector determined in step S285 is supplied to the arithmetic operation unit 235 in this case.

If the view ID of the reference image index and the view ID of the reference view image are determined to be different in step S286, the predicted vector generation unit 234 in step S287 performs scaling on the predicted vector determined in step S285. Specifically, the predicted vector generation unit 234 supplies the value obtained by performing scaling on the minimum disparity value in accordance with the viewpoint distance of the view image as the predicted vector to the arithmetic operation unit 235, and the motion disparity vector generation process is ended.

In a case where the reference image indicated by the reference image index is an image of the same view as the current image at a different time from the current image, on the other hand, the predicted vector is determined not to be a disparity vector in step S280, and the process moves on to step S288. In step S288, the predicted vector generation unit 234 sets the predicted vector to the initial value (0). Specifically, the predicted vector generation unit 234 supplies the 0 vector as the predicted vector to the arithmetic operation unit 235 in step S288, and the motion disparity vector generation process is then ended.

As described above, in a case where it is not possible to refer to any of the peripheral regions when a disparity vector is to be predicted, the maximum disparity value or the minimum disparity value in the picture is set as the predicted vector. In this manner, precision of the predicted vector of the disparity vector can be improved. Specifically, the difference value with respect to a transmitted disparity vector is smaller than in a case where a 0 vector is set as the predicted vector and a motion disparity vector is transmitted as it is as in conventional cases. Accordingly, encoding efficiency is increased.

Also, it is considered that a disparity vector is generated between a minimum disparity value and a maximum disparity value defined in a slice header. Accordingly, where it is not possible to refer to any peripheral region, a predicted vector with stochastically high precision can be generated by setting the minimum value or the maximum value as the predicted vector.

Further, which of the minimum value and the maximum value is better as a predicted vector depends on scenes, and therefore, a predicted vector with higher precision can be generated by setting a flag indicating which of the minimum value and the maximum value is better in the slice header.

Also, the maximum disparity value and the minimum disparity value, and the reference view information are the information necessary for adjusting disparity and combining viewpoints on the display side. Therefore, such information is included in the slice header to be transmitted, and is used to achieve higher efficiency.

The maximum disparity value to be used as a predicted vector may be a predetermined upper limit value in a disparity range, or the minimum disparity value may be a predetermined lower limit value in a disparity range. Also, the mean value of disparity in pictures can be used as a predicted vector. Further, a predetermined value (a set value) in a disparity range may be used as a predicted vector.

Although the maximum disparity value and the minimum disparity value are used as predicted vectors in the present technique, the above described maximum disparity value, the minimum disparity value, the upper limit value, the lower limit value, the mean value, or the predetermined value may be used as a candidate vector among motion disparity vectors.

Although the encoding method described above is based on H.264/AVC or HEVC, the present disclosure is not limited to that, and can be applied to other encoding/decoding methods.

The present disclosure can be applied to image encoding devices and image decoding devices that are used when image information (bit streams) compressed through orthogonal transforms such as discrete cosine transforms and motion compensation is received via a network medium such as satellite broadcasting, cable television, the Internet, or a portable telephone device, as in MPEG or H.26×, for example. The present disclosure can also be applied to image encoding devices and image decoding devices that are used when compressed image information is processed on a storage medium such as an optical or magnetic disk or a flash memory. Further, the present disclosure can be applied to motion prediction/compensation devices included in such image encoding devices and image decoding devices.

### 4. Third Embodiment

### [Personal Computer]

The series of processes described above can be performed either by hardware or by software. When the series of processes described above is performed by software, programs constituting the software are installed in a computer. Note that examples of the computer include a computer embedded in dedicated hardware and a general-purpose personal computer capable of executing various functions by installing various programs therein.

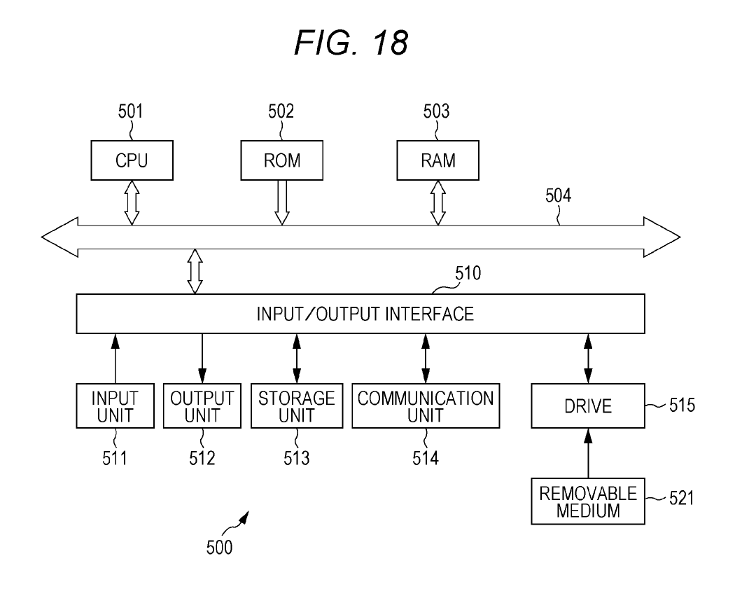

In FIG. 18, a CPU (central processing unit) 501 of a personal computer 500 performs various processes according to programs stored in a ROM (read only memory) 502 or programs loaded onto a RAM (random access memory) 503 from a storage unit 513. The RAM 503 also stores data necessary for the CPU 501 to perform various processes and the like as necessary.

The CPU 501, the ROM 502, and the RAM 503 are connected to one another via a bus 504. An input/output interface 510 is also connected to the bus 504.

The input/output interface 510 has the following components connected thereto: an input unit 511 including a keyboard, a mouse, or the like; an output unit 512 including a display such as a CRT (cathode ray tube) or a LCD (liquid crystal display), and a speaker; the storage unit 513 including a hard disk or the like; and a communication unit 514 including a modem or the like. The communication unit 514 performs communications via networks including the Internet.

A drive 515 is also connected to the input/output interface 510 where necessary, a removable medium 521 such as a magnetic disk, an optical disk, a magnetooptical disk, or a semiconductor memory is mounted on the drive as appropriate, and a computer program read from such a removable disk is installed in the storage unit 513 where necessary.

When the above described series of processes is performed by software, the programs constituting the software are installed from a network or a recording medium.

As shown in FIG. 18, examples of the recording medium include the removable medium 521 that is distributed for delivering programs to users separately from the device, such as a magnetic disk (including a flexible disk), an optical disk (including a CD-ROM (compact disc-read only memory) or a DVD (digital versatile disc)), a magnetooptical disk (including an MD (mini disc)), and a semiconductor memory, which has programs recorded thereon, and alternatively, the ROM 502 having programs recorded therein and a hard disk included in the storage unit 513, which are incorporated beforehand into the device prior to delivery to users.

Programs to be executed by the computer may be programs for carrying out processes in chronological order in accordance with the sequence described in this specification, or programs for carrying out processes in parallel or at necessary timing such as in response to a call.

In this specification, steps describing programs to be recorded in a recording medium include processes to be performed in parallel or independently of one another if not necessarily in chronological order, as well as processes to be performed in chronological order in accordance with the sequence described herein.

In this specification, a system refers to the entirety of equipment including more than one device.

Furthermore, any structure described above as one device (or one processing unit) may be divided into two or more devices (or processing units). Conversely, any structure described above as two or more devices (or processing units) may be combined into one device (or processing unit). Furthermore, it is of course possible to add components other than those described above to the structure of any of the devices (or processing units). Furthermore, some components of a device (or processing unit) may be incorporated into the structure of another device (or processing unit) as long as the structure and the function of the system as a whole are substantially the same. That is, the present technique is not limited to the embodiments described above, but various modifications may be made thereto without departing from the scope of the technique.

The image encoding devices and the image decoding devices according to the embodiments described above can be applied to various electronic devices such as transmitters and receivers in satellite broadcasting, cable broadcasting such as cable TV, distribution via the Internet, distribution to terminals via cellular communication, or the like, recording devices configured to record images in media such as magnetic discs and flash memory, and reproduction devices configured to reproduce images from the storage media. Four examples of applications will be described below.

### 5. Fourth Embodiment

### [First Application: Television Receiver]

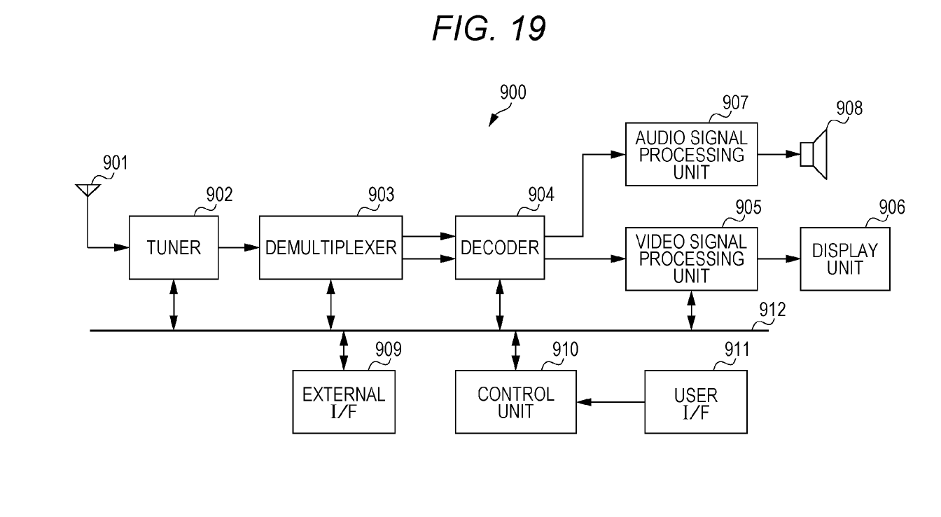

FIG. 19 schematically shows an example structure of a television apparatus to which the above described embodiments are applied. The television apparatus 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from broadcast signals received via the antenna 901, and demodulates the extracted signal. The tuner 902 then outputs an encoded bit stream obtained by the demodulation to the demultiplexer 903. That is, the tuner 902 serves as transmitting means in the television apparatus 900 that receives an encoded stream of encoded images.

The demultiplexer 903 separates a video stream and an audio stream of a program to be viewed from the encoded bit stream, and outputs the separated streams to the decoder 904. The demultiplexer 903 also extracts auxiliary data such as an EPG (electronic program guide) from the encoded bit stream, and supplies the extracted data to the control unit 910. If the encoded bit stream is scrambled, the demultiplexer 903 may descramble the encoded bit stream.

The decoder 904 decodes the video stream and the audio stream input from the demultiplexer 903. The decoder 904 then outputs video data generated by the decoding to the video signal processing unit 905. The decoder 904 also outputs audio data generated by the decoding to the audio signal processing unit 907.

The video signal processing unit 905 reproduces video data input from the decoder 904, and displays the video data on the display unit 906. The video signal processing unit 905 may also display an application screen supplied via the network on the display unit 906. Furthermore, the video signal processing unit 905 may perform additional processing such as noise removal on the video data depending on settings. The video signal processing unit 905 may further generate an image of a GUI (graphical user interface) such as a menu, a button or a cursor and superimpose the generated image on the output images.

The display unit 906 is driven by a drive signal supplied from the video signal processing unit 905, and displays video or images on a video screen of a display device(such as a liquid crystal display, a plasma display, or an OELD (organic electroluminescence display).

The audio signal processing unit 907 performs reproduction processing such as D/A conversion and amplification on the audio data input from the decoder 904, and outputs audio through the speaker 908. Furthermore, the audio signal processing unit 907 may perform additional processing such as noise removal on the audio data.

The external interface 909 is an interface for connecting the television apparatus 900 to an external device or a network. For example, a video stream or an audio stream received via the external interface 909 may be decoded by the decoder 904. That is, the external interface 909 also serves as transmitting means in the television apparatus 900 that receives an encoded stream of encoded images.

The control unit 910 includes a processor such as a CPU, and a memory such as a RAM or a ROM. The memory stores programs to be executed by the CPU, program data, EPG data, data acquired via the network, and the like. Programs stored in the memory are read and executed by the CPU when the television apparatus 900 is activated, for example. The CPU controls the operation of the television apparatus 900 according to control signals input from the user interface 911, for example, by executing the programs.

The user interface 911 is connected to the control unit 910. The user interface 911 includes buttons and switches for users to operate the television apparatus 900 and a receiving unit for receiving remote control signals, for example. The user interface 911 detects a user operation via these components, generates a control signal, and outputs the generated control signal to the control unit 910.

The bus 912 connects the tuner 902, the demultiplexer 903, the decoder 904, the video signal processing unit 905, the audio signal processing unit 907, the external interface 909, and the control unit 910 to one another.

In the television apparatus 900 having such a structure, the decoder 904 has the functions of the image decoding device according to the embodiments described above. Accordingly, when images are decoded in the television apparatus 900, block distortions can be removed more appropriately, and higher subjective image quality can be achieved in decoded images.

### 6. Fifth Embodiment

### [Second Application: Portable Telephone Device]

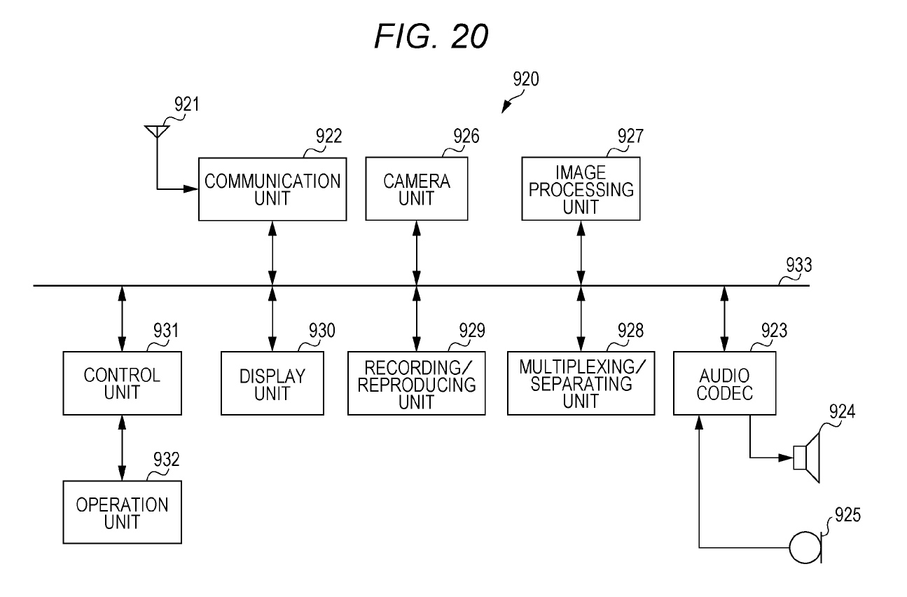

FIG. 20 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 920 performs operation such as transmission/reception of audio signals, transmission/reception of electronic mails and image data, capturing of images, recording of data, and the like in various operation modes including a voice call mode, a data communication mode, an imaging mode, and a video telephone mode.

In the voice call mode, an analog audio signal generated by the microphone 925 is supplied to the audio codec 923. The audio codec 923 converts the analog audio signal to audio data, performs an A/D conversion on the converted audio data, and compresses the audio data. The audio codec 923 then outputs the audio data resulting from the compression to the communication unit 922. The communication unit 922 encodes and modulates the audio data to generate a signal to be transmitted. The communication unit 922 then transmits the generated signal to be transmitted to a base station (not shown) via the antenna 921. The communication unit 922 also performs amplification and a frequency conversion on a radio signal received via the antenna 921, and obtains a received signal. The communication unit 922 then demodulates and decodes the received signal to generate audio data, and outputs the generated audio data to the audio codec 923. The audio codec 923 performs decompression and a D/A conversion on the audio data, to generate an analog audio signal. The audio codec 923 then supplies the generated audio signal to the speaker 924 to output audio therefrom.

In the data communication mode, the control unit 931 generates text data to be included in an electronic mail according to operation by a user via the operation unit 932, for example. The control unit 931 also displays the text on the display unit 930. The control unit 931 also generates electronic mail data in response to an instruction for transmission from a user via the operation unit 932, and outputs the generated electronic mail data to the communication unit 922. The communication unit 922 encodes and modulates the electronic mail data to generate a signal to be transmitted. The communication unit 922 then transmits the generated signal to be transmitted to a base station (not shown) via the antenna 921. The communication unit 922 also performs amplification and a frequency conversion on a radio signal received via the antenna 921, and obtains a received signal. The communication unit 922 then demodulates and decodes the received signal to restore electronic mail data, and outputs the restored electronic mail data to the control unit 931. The control unit 931 displays the content of the electronic mail on the display unit 930 and stores the electronic mail data into a storage medium of the recording/reproducing unit 929.

The recording/reproducing unit 929 includes a readable/writable storage medium. For example, the storage medium may be an internal storage medium such as a RAM or flash memory, or may be an externally mounted storage medium such as a hard disk, a magnetic disk, a magnetooptical disk, a USB (unallocated space bitmap) memory, or a memory card.

In the imaging mode, the camera unit 926 images an object to generate image data, and outputs the generated image data to the image processing unit 927, for example. The image processing unit 927 encodes the image data input from the camera unit 926, and stores an encoded stream in the storage medium of the storage/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream to generate a signal to be transmitted. The communication unit 922 then transmits the generated signal to be transmitted to a base station (not shown) via the antenna 921. The communication unit 922 also performs amplification and a frequency conversion on a radio signal received via the antenna 921, and obtains a received signal. The signal to be transmitted and the received signal may include encoded bit streams. The communication unit 922 restores a stream by demodulating and decoding the received signal, and outputs the restored stream to the multiplexing/separating unit 928. The multiplexing/separating unit 928 separates a video stream and an audio stream from the input stream, and outputs the video stream to the image processing unit 927 and the audio stream to the audio codec 923. The image processing unit 927 decodes the video stream to generate video data. The video data is supplied to the display unit 930, and a series of images is displayed by the display unit 930. The audio codec 923 performs decompression and a D/A conversion on the audio stream, to generate an analog audio signal. The audio codec 923 then supplies the generated audio signal to the speaker 924 to output audio therefrom.

In the portable telephone device 920 having such a structure, the image processing unit 927 has the functions of the image encoding device and the image decoding device according to the embodiments described above. Accordingly, when images are encoded and decoded in the portable telephone device 920, block distortions can be removed more appropriately, and higher subjective image quality can be achieved in decoded images.

### 7. Sixth Embodiment

### [Third Application: Recording/Reproducing Device]

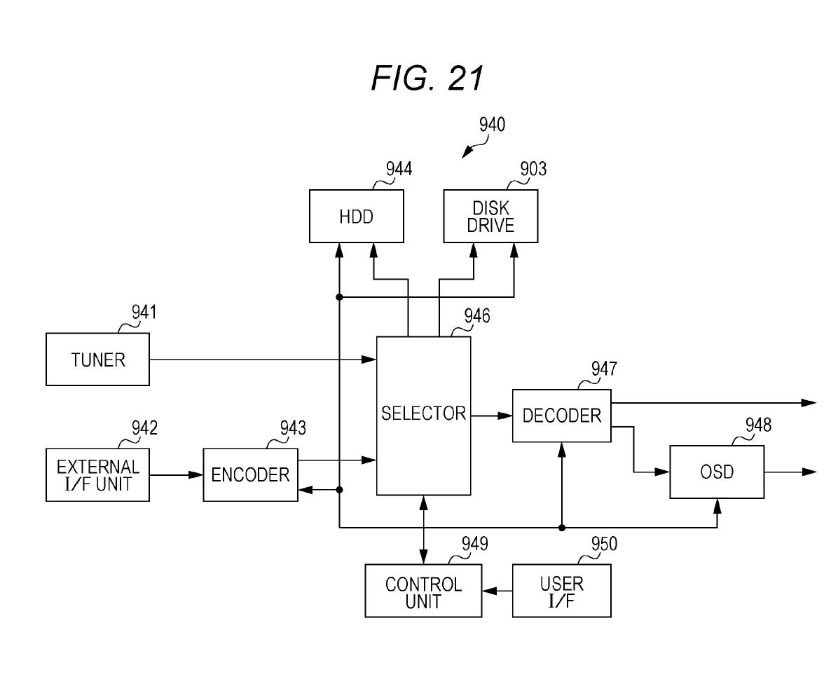

FIG. 21 schematically shows an example structure of a recording/reproducing device to which the above described embodiments are applied. The recording/reproducing device 940 encodes audio data and video data of a received broadcast program and records the encoded data into a recording medium, for example. The recording/reproducing device 940 may also encode audio data and video data acquired from another device and record the encoded data into a recording medium, for example. The recording/reproducing device 940 also reproduces data recorded in the recording medium on a monitor and through a speaker in response to an instruction from a user, for example. In this case, the recording/reproducing device 940 decodes audio data and video data.

The recording/reproducing device 940 includes a tuner 941, an external interface 942, an encoder 943, an HDD (hard disk drive) 944, a disk drive 945, a selector 946, a decoder 947, an OSD (on-screen display) 948, a control unit 949, and a user interface 950.

The tuner 941 extracts a signal of a desired channel from broadcast signals received via an antenna (not shown), and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface for connecting the recording/reproducing device 940 with an external device or a network. The external interface 942 may be an IEEE 1394 interface, a network interface, a USB interface, or a flash memory interface, for example. For example, video data and audio data received via the external interface 942 are input to the encoder 943. That is, the external interface 942 has a role as transmission means in the recording/reproducing device 940.

The encoder 943 encodes the video data and the audio data if the video data and the audio data input from the external interface 942 are not encoded. The encoder 943 then outputs the encoded bit stream to the selector 946.

The HDD 944 records an encoded bit stream of compressed content data such as video and audio, various programs and other data in an internal hard disk. The HDD 944 also reads out the data from the hard disk for reproduction of video and audio.

The disk drive 945 records and reads out data into/from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (a registered trademark) disc, for example.

For recording video and audio, the selector 946 selects an encoded bit stream input from the tuner 941 or the encoder 943 and outputs the selected encoded bit stream to the HDD 944 or the disk drive 945. For reproducing video and audio, the selector 946 selects an encoded bit stream input from the HDD 944 or the disk drive 945 to the decoder 947.

The decoder 947 decodes the encoded bit stream to generate video data and audio data. The decoder 947 then outputs the generated video data to the OSD 948. The decoder 904 also outputs the generated audio data to an external speaker.

The OSD 948 reproduces the video data input from the decoder 947 and displays the video. The OSD 948 may also superimpose a GUI image such as a menu, a button or a cursor on the video to be displayed.

The control unit 949 includes a processor such as a CPU, and a memory such as a RAM and a ROM. The memory stores programs to be executed by the CPU, program data, and the like. Programs stored in the memory are read and executed by the CPU when the recording/reproducing device 940 is activated, for example. The CPU controls the operation of the recording/reproducing device 940 according to control signals input from the user interface 950, for example, by executing the programs.

The user interface 950 is connected to the control unit 949. The user interface 950 includes buttons and switches for users to operate the recording/reproducing device 940 and a receiving unit for receiving remote control signals, for example. The user interface 950 detects operation by a user via these components, generates a control signal, and outputs the generated control signal to the control unit 949.

In the recording/reproducing device 940 having such a structure, the encoder 943 has the functions of the image encoding devices according to the embodiments described above. Furthermore, the decoder 947 has the functions of the image decoding devices according to the embodiments described above. Accordingly, when images are encoded and decoded in the recording/reproducing device 940, block distortions can be removed more appropriately, and higher subjective image quality can be achieved in decoded images.

### 8. Seventh Embodiment

### [Fourth Application: Imaging Device]

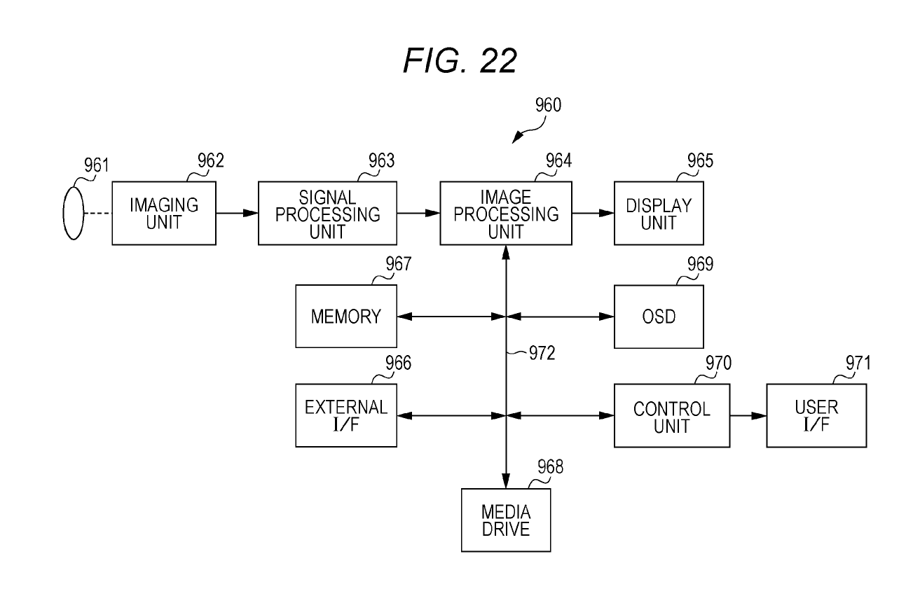

FIG. 22 schematically shows an example structure of an imaging device to which the above described embodiments are applied. The imaging device 960 images an object to generate an image, encodes the image data, and records the encoded image data in a recording medium.

The imaging device 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to one another.

The optical block 961 includes a focus lens, a diaphragm, and the like. The optical block 961 forms an optical image of an object on the imaging surface of the imaging unit 962. The imaging unit 962 includes an image sensor such as a CCD (charge coupled device) or a CMOS (complementary metal oxide semiconductor), and converts the optical image formed on the imaging surface into an image signal that is an electric signal through photoelectric conversion. The imaging unit 962 then outputs the image signal to the signal processing unit 963.

The signal processing unit 963 performs various kinds of camera signal processing such as knee correction, gamma correction, and color correction on the image signal input from the imaging unit 962. The signal processing unit 963 outputs image data subjected to the camera signal processing to the image processing unit 964.

The image processing unit 964 encodes the image data input from the signal processing unit 963 to generate encoded data. The image processing unit 964 then outputs the generated encoded data to the external interface 966 or the media drive 968. The image processing unit 964 also decodes encoded data input from the external interface 966 or the media drive 968 to generate image data. The image processing unit 964 then outputs the generated image data to the display unit 965. The image processing unit 964 may output image data input from the signal processing unit 963 to the display unit 965 to display images. The image processing unit 964 may also superimpose data for display acquired from the OSD 969 on the images to be output to the display unit 965.

The OSD 969 may generate a GUI image such as a menu, a button or a cursor and output the generated image to the image processing unit 964, for example.

The external interface 966 is a USB input/output terminal, for example. The external interface 966 connects the imaging device 960 and a printer for printing of an image, for example. In addition, a drive is connected to the external interface 966 as necessary. A removable medium such as a magnetic disk or an optical disk is mounted to the drive, for example, and a program read out from the removable medium can be installed in the imaging device 960. Furthermore, the external interface 966 may be a network interface connected to a network such as a LAN or the Internet. That is, the external interface 966 has a role as transmission means in the imaging device 960.

The recording medium to be mounted on the media drive 968 may be a readable/writable removable medium such as a magnetic disk, a magnetooptical disk, an optical disk or a semiconductor memory. Alternatively, a recording medium may be mounted on the media drive 968 in a fixed manner to form an immobile storage unit such as an internal hard disk drive or an SSD (solid state drive), for example.

The control unit 970 includes a processor such as a CPU, and a memory such as a RAM and a ROM. The memory stores programs to be executed by the CPU, program data, and the like. Programs stored in the memory are read and executed by the CPU when the imaging device 960 is activated, for example. The CPU controls the operation of the imaging device 960 according to control signals input from the user interface 971, for example, by executing the programs.

The user interface 971 is connected to the control unit 970. The user interface 971 includes buttons and switches for users to operate the imaging device 960, for example. The user interface 971 detects operation by a user via these components, generates a control signal, and outputs the generated control signal to the control unit 970.

In the imaging device 960 having such a structure, the image processing unit 964 has the functions of the image encoding devices and the image decoding devices according to the embodiments described above. Accordingly, when images are encoded and decoded in the imaging device 960, block distortions can be removed more appropriately, and higher subjective image quality can be achieved in decoded images.

In this specification, examples in which various information pieces such as difference quantization parameters are multiplexed with an encoded stream and are transmitted from the encoding side to the decoding side have been described. However, the method of transmitting the information is not limited to the above examples. For example, the information pieces may be transmitted or recorded as separate data associated with an encoded bit stream, without being multiplexed with the encoded bit stream. Note that the term “associate” means to allow images (which may be part of images such as slices or blocks) contained in a bit stream to be linked to the information corresponding to the images at the time of decoding. That is, the information may be transmitted via a transmission path different from that for the images (or the bit stream). Alternatively, the information may be recorded in a recording medium other than that for the images (or the bit stream) (or on a different area of the same recording medium). Furthermore, the information and the images (or the bit stream) may be associated with each other in any units such as in units of some frames, one frame or part of a frame.

While preferred embodiments of the present disclosure have been described above with reference to the accompanying drawings, the present disclosure is not limited to those examples. It is apparent that those who have ordinary skills in the art can make various changes or modifications within the scope of the technical spirit claimed herein, and it should be understood that those changes or modifications are within the technical scope of the present disclosure.

The present technique can also have the following structures.

(1) An image processing device including:

a decoding unit that generates an image by decoding a bit stream;

a predicted vector determination unit that determines a predicted vector to be the upper limit value or the lower limit value of a range of inter-image disparity between the image obtained from the bit stream and a view image having different disparity from the image at the same time, when a disparity vector of a region to be decoded in the image generated by the decoding unit is to be predicted and it is not possible to refer to any of peripheral regions located in the vicinity of the region; and

a predicted image generation unit that generates a predicted image of the image generated by the decoding unit, using the predicted vector determined by the predicted vector determination unit.

(2) The image processing device of (1), wherein the upper limit value or the lower limit value of the range of the inter-image disparity is the maximum value or the minimum value of the inter-image disparity.

(3) The image processing device of (1) or (2), wherein

the decoding receives a flag indicating which of the upper limit value and the lower limit value of the range of the inter-image disparity is to be used as the predicted vector, and

the predicted vector determination unit determines the predicted vector to be the value indicated by the flag received by the decoding.

(4) The image processing device of any of (1) through (3), wherein the predicted vector generation unit determines the predicted vector to be one of the upper limit value, the lower limit value, and the mean value of the range of the inter-image disparity.

(5) The image processing device of any of (1) through (3), wherein the predicted vector generation unit determines the predicted vector to be one of the upper limit value and the lower limit value of the range of the inter-image disparity and a predetermined value within the range of the inter-image disparity.

(6) The image processing device of any of (1) through (5), wherein the predicted vector generation unit determines the predicted vector to be the value obtained by performing scaling on the upper limit value or the lower limit value of the range of inter-image disparity, when the image indicated by the reference image index of the image differs from the view image.

(7) An image processing method including:

generating an image by decoding a bit stream;

determining a predicted vector to be the upper limit value or the lower limit value of a range of inter-image disparity between the image obtained from the bit stream and a view image having different disparity from the image at the same time, when a disparity vector of a region to be decoded in the generated image is to be predicted and it is not possible to refer to any of peripheral regions located in the vicinity of the region; and

generating a predicted image of the generated image, using the determined predicted vector,

an image processing device generating the image, determining the predicted vector, and generating the predicted image.

(8) An image processing device including:

a predicted vector determination unit that determines a predicted vector to be the upper limit value or the lower limit value of a range of inter-image disparity between an image and a view image having different disparity from the image at the same time, when a disparity vector of a region to be encoded in the image is to be predicted and it is not possible to refer to any of peripheral regions located in the vicinity of the region; and

an encoding unit that encodes a difference between the disparity vector of the region and the predicted vector determined by the predicted vector determination unit.

(9) The image processing device of (8), wherein the upper limit value or the lower limit value of the range of the inter-image disparity is the maximum value or the minimum value of the inter-image disparity.

(10) The image processing device of (8) or (9), further including:

a transmission unit that transmits a flag indicating which of the upper limit value and the lower limit value of the range of the inter-image disparity has been determined as the predicted vector by the predicted vector determination unit, and an encoded stream generated by encoding the image.

(11) The image processing device of any of (8) through (10), wherein the predicted vector generation unit determines the predicted vector to be one of the upper limit value, the lower limit value, and the mean value of the range of the inter-image disparity.

(12) The image processing device of any of (8) through (10), wherein the predicted vector generation unit determines the predicted vector to be one of the upper limit value and the lower limit value of the range of the inter-image disparity and a predetermined value within the range of the inter-image disparity.

(13) The image processing device of any of (8) through (12), wherein the predicted vector generation unit determines the predicted vector to be a value obtained by performing scaling on the upper limit value or the lower limit value of the range of the inter-image disparity, when the image indicated by the reference image index of the image differs from the view image.

(14) An image processing method including:

determining a predicted vector to be the upper limit value or the lower limit value of a range of inter-image disparity between an image and a view image having different disparity from the image at the same time, when a disparity vector of a region to be encoded in the image is to be predicted and it is not possible to refer to any of peripheral regions located in the vicinity of the region; and

encoding a difference between the disparity vector of the region and the determined predicted vector,

an image processing device determining the predicted vector and encoding the difference.

### REFERENCE SIGNS LIST

100 Image encoding device, 106 Lossless encoding unit, 115 Motion disparity prediction/compensation unit, 121 Multi-view decoded picture buffer, 122 Disparity detection unit, 135 Encoding information buffer, 136 Spatial predicted vector generation unit, 137 Temporal-disparity predicted vector generation unit, 138 Predicted vector generation unit, 133 Encoding cost calculation unit, 134 Mode determination unit, 200 Image decoding device, 202 Lossless decoding unit, 212 Motion disparity prediction/compensation unit, 221 Multi-view decoded picture buffer, 231 Encoding information buffer, 232 Spatial predicted vector generation unit, 233 Temporal-disparity predicted vector generation unit, 234 Predicted vector generation unit

1. An image processing device comprising:
a decoding unit configured to generate an image by decoding a bit stream;
a predicted vector determination unit configured to determine a predicted vector to be an upper limit value or a lower limit value of a range of inter-image disparity between the image obtained from the bit stream and a view image having different disparity from the image at the same time, when a disparity vector of a region to be decoded in the image generated by the decoding unit is to be predicted and it is not possible to refer to any of peripheral regions located in the vicinity of the region; and
a predicted image generation unit configured to generate a predicted image of the image generated by the decoding unit, using the predicted vector determined by the predicted vector determination unit.

2. The image processing device according to claim 1, wherein the upper limit value or the lower limit value of the range of the inter-image disparity is a maximum value or a minimum value of the inter-image disparity.

3. The image processing device according to claim 1, wherein
the decoding receives a flag indicating which of the upper limit value and the lower limit value of the range of the inter-image disparity is to be used as the predicted vector, and
the predicted vector determination unit determines the predicted vector to be the value indicated by the flag received by the decoding.

4. The image processing device according to claim 1, wherein the predicted vector generation unit determines the predicted vector to be one of the upper limit value, the lower limit value, and the mean value of the range of the inter-image disparity.

5. The image processing device according to claim 1, wherein the predicted vector generation unit determines the predicted vector to be one of the upper limit value and the lower limit value of the range of the inter-image disparity and a predetermined value within the range of the inter-image disparity.

6. The image processing device according to claim 1, wherein the predicted vector generation unit determines the predicted vector to be a value obtained by performing scaling on the upper limit value or the lower limit value of the range of the inter-image disparity, when an image indicated by a reference image index of the image differs from the view image.

7. An image processing method comprising:
generating an image by decoding a bit stream;
determining a predicted vector to be an upper limit value or a lower limit value of a range of inter-image disparity between the image obtained from the bit stream and a view image having different disparity from the image at the same time, when a disparity vector of a region to be decoded in the generated image is to be predicted and it is not possible to refer to any of peripheral regions located in the vicinity of the region; and
generating a predicted image of the generated image, using the determined predicted vector,
an image processing device generating the image, determining the predicted vector, and generating the predicted image.

8. An image processing device comprising:
a predicted vector determination unit configured to determine a predicted vector to be an upper limit value or a lower limit value of a range of inter-image disparity between an image and a view image having different disparity from the image at the same time, when a disparity vector of a region to be encoded in the image is to be predicted and it is not possible to refer to any of peripheral regions located in the vicinity of the region; and
an encoding unit configured to encode a difference between the disparity vector of the region and the predicted vector determined by the predicted vector determination unit.

9. The image processing device according to claim 8, wherein the upper limit value or the lower limit value of the range of the inter-image disparity is a maximum value or a minimum value of the inter-image disparity.

10. The image processing device according to claim 8, further comprising:
a transmission unit configured to transmit a flag indicating which of the upper limit value and the lower limit value of the range of the inter-image disparity has been determined as the predicted vector by the predicted vector determination unit, and an encoded stream generated by encoding the image.

11. The image processing device according to claim 8, wherein the predicted vector generation unit determines the predicted vector to be one of the upper limit value, the lower limit value, and the mean value of the range of the inter-image disparity.

12. The image processing device according to claim 8, wherein the predicted vector generation unit determines the predicted vector to be one of the upper limit value and the lower limit value of the range of the inter-image disparity and a predetermined value within the range of the inter-image disparity.

13. The image processing device according to claim 8, wherein the predicted vector generation unit determines the predicted vector to be a value obtained by performing scaling on the upper limit value or the lower limit value of the range of the inter-image disparity, when an image indicated by a reference image index of the image differs from the view image.

14. An image processing method including:
determining a predicted vector to be an upper limit value or a lower limit value of a range of inter-image disparity between an image and a view image having different disparity from the image at the same time, when a disparity vector of a region to be encoded in the image is to be predicted and it is not possible to refer to any of peripheral regions located in the vicinity of the region; and
encoding a difference between the disparity vector of the region and the determined predicted vector,
an image processing device determining the predicted vector and encoding the difference.
